(19) United States
(12) Patent Application Publication
(10) Pub. No.: US 2024/0334363 A1
(43) Pub. Date: Oct. 3, 2024

(54) ALTITUDE-DEPENDENT MEASUREMENT AND REPORTING CONFIGURATIONS

(71) Applicant: QUALCOMM Incorporated, San Diego, CA (US)

(72) Inventors: Chiranjib SAHA, Lakeside, CA (US); Umesh PHUYAL, San Diego, CA (US); Le LIU, San Jose, CA (US); Bharat SHRESTHA, San Diego, CA (US); Changhwan PARK, San Diego, CA (US); Alberto RICO ALVARINO, San Diego, CA (US); Peter GAAL, San Diego, CA (US)

(21) Appl. No.: 18/603,050

(22) Filed: Mar. 12, 2024

Related U.S. Application Data
(60) Provisional application No. 63/493,994, filed on Apr. 3, 2023.

(51) Int. Cl. H04W 56/00; H04W 84/06

(52) U.S. Cl. CPC H04W 56/006; H04W 56/0015; H04W 84/06

(57) ABSTRACT

Apparatuses and methods for altitude-dependent measurement and reporting configurations are described. An apparatus is configured to receive, from a network node, a measurement object configuration, where the measurement object configuration indicates at least one altitude parameter associated with a set of SSBs. The apparatus is also configured to measure a SSB value for each SSB in the set of SSBs based on the measurement object configuration and an altitude of the UE. An additional apparatus is configured to configure, for a UE, a measurement object configuration, where the measurement object configuration indicates at least one altitude parameter associated with a set of SSBs. The additional apparatus is also configured to provide the set of SSBs indicated in the measurement object configuration.

### CROSS REFERENCE TO RELATED APPLICATION(S)

This application claims the benefit of and priority to U.S. Provisional Application Ser. No. 63/493,994, entitled “ALTITUDE-DEPENDENT MEASUREMENT AND REPORTING CONFIGURATIONS” and filed on Apr. 3, 2023, which is expressly incorporated by reference herein in its entirety.

### TECHNICAL FIELD

The present disclosure relates generally to communication systems, and more particularly, to wireless communications utilizing signal measurements.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (cMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus, which may be a user equipment (UE), is configured to receive, from a network node, a measurement object configuration, where the measurement object configuration indicates at least one altitude parameter associated with a set of SSBs. The apparatus is also configured to measure a SSB value for each SSB in the set of SSBs based on the measurement object configuration and an altitude of the UE.

In the aspect, the method includes receiving, from a network node, a measurement object configuration, where the measurement object configuration indicates at least one altitude parameter associated with a set of SSBs. The method also includes measuring a SSB value for each SSB in the set of SSBs based on the measurement object configuration and an altitude of the UE.

In another aspect of the disclosure, a method, a computer-readable medium, and an apparatus are provided. The apparatus is configured to configure, for a UE, a measurement object configuration, where the measurement object configuration indicates at least one altitude parameter associated with a set of SSBs. The apparatus is also configured to provide the set of SSBs indicated in the measurement object configuration.

In the aspect, the method includes configuring, for a UE, a measurement object configuration, where the measurement object configuration indicates at least one altitude parameter associated with a set of SSBs. The method also includes providing the set of SSBs indicated in the measurement object configuration.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example communication system having UEs located at different heights or altitudes.

FIG. 5 is a diagram illustrating examples of beam measurements for synchronization signal block (SSB) bursts, in accordance with various aspects of the present disclosure.

FIG. 6 is a diagram illustrating an example of a measurement object information element (IE), in accordance with various aspects of the present disclosure.

FIG. 7 is a diagram illustrating an example of a machine type communication (MTC) IE, in accordance with various aspects of the present disclosure.

FIG. 8 is a call flow diagram for wireless communications, in accordance with various aspects of the present disclosure.

FIG. 9 is a diagram illustrating example configurations for altitude-dependent measurement and reporting, in accordance with various aspects of the present disclosure.

FIG. 10 is a diagram illustrating an example configuration for altitude-dependent measurement and reporting, in accordance with various aspects of the present disclosure.

FIG. 11 is a diagram is a diagram illustrating an example configuration for altitude-dependent measurement and reporting, in accordance with various aspects of the present disclosure.

FIG. 12 is a diagram illustrating an example configuration for altitude-dependent measurement and reporting, in accordance with various aspects of the present disclosure.

FIG. 13 is a flowchart of a method of wireless communication, in accordance with various aspects of the present disclosure.

FIG. 14 is a flowchart of a method of wireless communication, in accordance with various aspects of the present disclosure.

FIG. 15 is a flowchart of a method of wireless communication, in accordance with various aspects of the present disclosure.

FIG. 16 is a flowchart of a method of wireless communication, in accordance with various aspects of the present disclosure.

FIG. 17 is a diagram illustrating an example of a hardware implementation for an example apparatus and/or network entity.

FIG. 18 is a diagram illustrating an example of a hardware implementation for an example network entity.

FIG. 19 is a diagram illustrating an example of a hardware implementation for an example network entity.

### DETAILED DESCRIPTION

Wireless communication networks, such as a 4G LTE network, a 5G NR network, etc., may enable measurements of directional communication beams by UEs, e.g., for beam management and/or mobility operations. In a 5G NR network, as one example, a given physical cell may exchange wireless communication via multiple beams, and a UE may measure multiple SSBs from the cell. Configurations for such measurements may be referred to as a measurement object configured for the UE, and may include a bitmap (“ssb-ToMeasure”) that indicates a set of SSBs to measure within a SMTC measurement duration. The ssb-ToMeasure may include a single bitmap in a measurement object for SSB measurements for mobility determinations (e.g., which may be referred to as an SSB-ConfigMobility object) and may apply to measurements in multiple measurement configurations, e.g., “smtc” and “smtc2,” for a given measurement object (e.g., which may be referred to as measObjectNR).

However, multiple measurement object configurations for a given SSB frequency (e.g., which may be referred to as “ssbFrequency”) may not be enabled or allowed for a cell group. For instance, some wireless networks may be implemented to ensure that, in the measurement configuration (which may be referred to as “measConfig”) associated with a configured grant (CG): (1) for all SSB based measurements there is at most one measurement object with the same ssbFrequency; and/or (2) an “smtc1” included in any measurement object with the same ssbFrequency has the same value, and that an smtc2 included in any measurement object with the same ssbFrequency has the same value, and that an “smtc3list” included in any measurement object with the same ssbFrequency has the same value, and that an “smtc4list” included in any measurement object with the same ssbFrequency has the same value. Aspects herein enable SMTCs with flexibility that allow for a UE (e.g., an unmanned aerial vehicle (UAV)) to measure a first set of beams (or [cell, beam] ordered pairs) at one altitude range (e.g., below or level with clutter) and a different set of beams at a different altitude range (e.g., above a certain altitude where line of sight (LOS) is usually expected), including for different cells. The altitude range, or altitude threshold or parameter, for the SSBs to be measurements enables the network to configure the UE to perform more efficient measurements by taking the potential for different UE altitudes into consideration.

Various aspects relate generally to wireless communications systems and measurement operations for wireless devices. Some aspects more specifically relate to altitude-dependent measurement and reporting configurations. In one example, a UE may receive, from a network node, a measurement object configuration, where the measurement object configuration indicates at least one altitude parameter associated with a set of SSBs. The UE may also measure a SSB value for each SSB in the set of SSBs based on the measurement object configuration and an altitude of the UE. In another example, a network node (e.g., a base station, gNB, etc.) may configure, for a UE, a measurement object configuration, where the measurement object configuration indicates at least one altitude parameter associated with a set of SSBs. The network node may also provide the set of SSBs indicated in the measurement object configuration.

Particular aspects of the subject matter described in this disclosure can be implemented to realize one or more of the following potential advantages. In some examples, by enabling configurations of altitude-specific measurements for synchronization signals, the described techniques can be used to improve flexibility and accuracy for positioning and mobility measurements at a UE. In some examples, by enabling configurations of altitude-specific measurements with altitude ranges/intervals for synchronization signals, the described techniques can be used to improve flexibility and accuracy for positioning and mobility measurements at a UE for specific synchronization signals based on UE altitude, e.g., for UAVs. In some examples, by enabling configurations of altitude-specific measurements with SSB-MTC lists in measurement objects, the described techniques can be used to provide SSB-MTC sub-configurations where each element of the SSB-MTC lists flexibly allows altitude ranges for flexibility and accuracy for positioning and mobility measurements at a UE for specific synchronization signals based on UE altitude.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

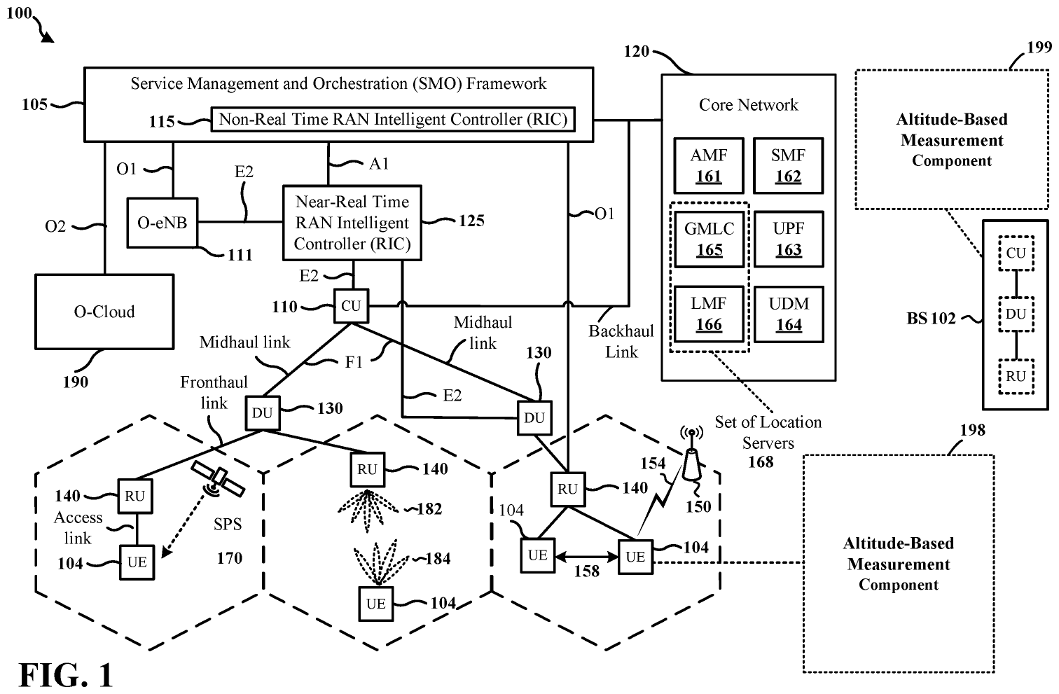

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell). Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FRI (410 MHZ-7.125 GHZ) and FR2 (24.25 GHz-52.6 GHZ). Although a portion of FR1 is greater than 6 GHz, FRI is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network. In aspects, a UE herein, e.g., the UEs 104, may be, or may be associated with, a UAV.

Referring again to FIG. 1, in certain aspects, the UE 104 may have an altitude based measurement component 198 (“component 198”) that may be configured to receive, from a network node, a measurement object configuration, where the measurement object configuration indicates at least one altitude parameter associated with a set of SSBs. The component 198 may also be configured to measure each SSB associated with the one or more cell identifiers based on an absence of a corresponding set of SSBs for the additional altitude parameter in the SMTC. The component 198 may be configured to obtain the altitude of the UE. To obtain the altitude of the UE, the component 198 may be configured to measure the altitude of the UE based on information received by the UE and/or receive an indication of the altitude of the UE from the network node or a network entity. The component 198 may be configured to report each measured SSB in the set of SSBs for the at least one physical cell at the altitude of the UE, based on a reporting configuration that is associated with the altitude of the UE, and at least one of the altitude, a location, a velocity, or a speed of the UE. In certain aspects, the base station 102 may have an altitude based measurement component 199 (“component 199”) that may be configured to configure, for a UE, a measurement object configuration, wherein the measurement object configuration indicates at least one altitude parameter associated with a set of SSBs. The component 199 may also be configured to provide the set of SSBs indicated in the measurement object configuration. The component 199 may be configured to obtain an altitude of the UE. The component 199 may be configured to measure the altitude of the UE based on information received from the UE. The component 199 may be configured to transmit, for the UE, an indication of the altitude of the UE. Accordingly, aspects herein provide for additional flexibility for beam measurements beyond what is provided in current solutions. Aspects herein enable SMTCs with flexibility that allow for a UE (e.g., a UAV) to measure a first set of beams (or [cell, beam] ordered pairs) at one altitude range (e.g., below or level with clutter) and a different set of beams at a different altitude range (e.g., above a certain altitude where line of sight (LOS) is usually expected), including for different cells and/or of different beams for different altitude ranges/intervals.

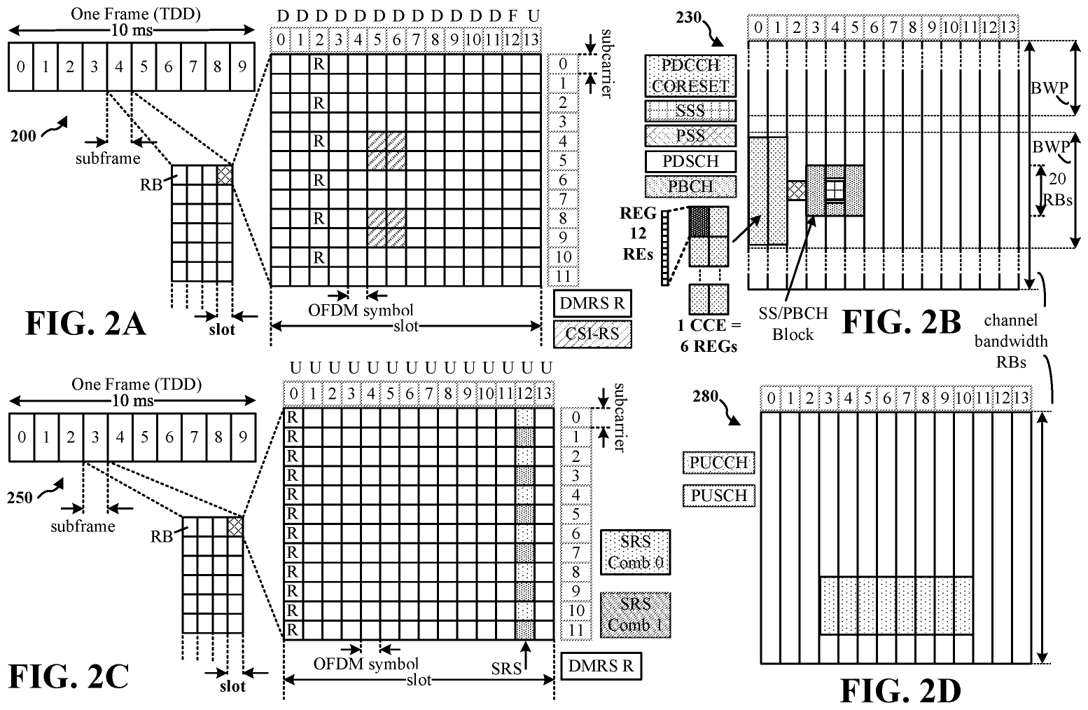

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

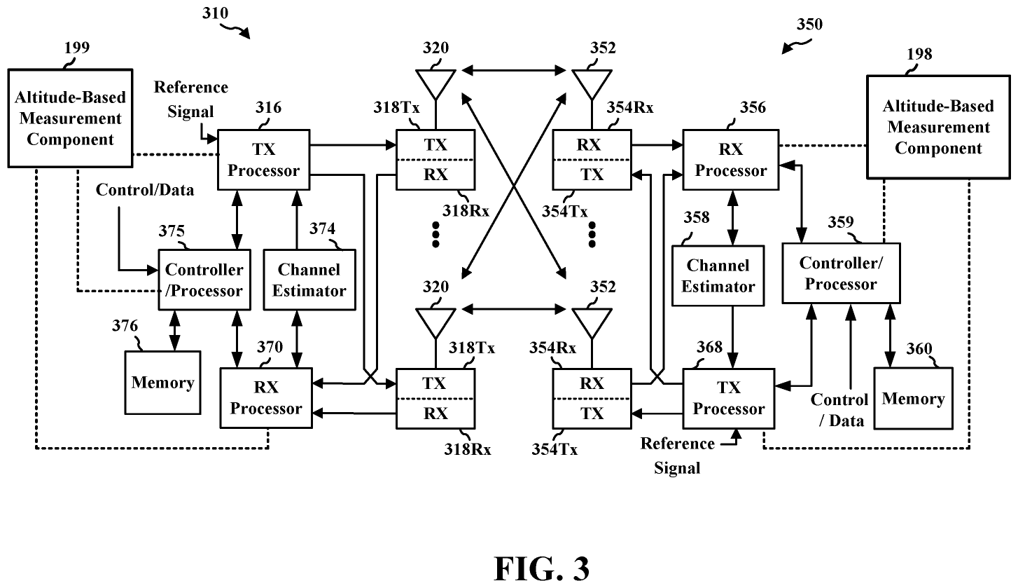

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 (also “at least one memory 360”) that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 (also “at least one memory 376”) that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the component 198 of FIG. 1. At least one of the TX processor 316, the RX processor 370, and the controller/processor 375 may be configured to perform aspects in connection with the component 199 of FIG. 1.

Among other examples, a UE may include a UAV or may be associated with a UAV. UAVs may include drones or other aircraft, and may include aircraft without a human pilot on board. In some aspects, UAVs may be operated remotely or autonomously based on a set of instructions, and may comprise sensors, cameras, and other instruments, such as but not limited to a UE. UAVs are used for various applications such as surveillance, wildlife conservation, disaster relief, delivery services, and aerial photography. They offer advantages such as the ability to reach hard-to-access locations. UAVs may reach different heights (e.g., which may be referred to interchangeably as altitude(s)) that terrestrial UEs are not able to access. UAVs may fly in the air at different altitudes, and UAVs that comprise a UE may cause interference to or from other distant UEs due to a line of sight channel. However, UAVs that comprise a UE and are on the ground, may cause interference, to a lesser extent than UAVs flying in the air, to or from other distant UEs due to a non-line of sight channel.

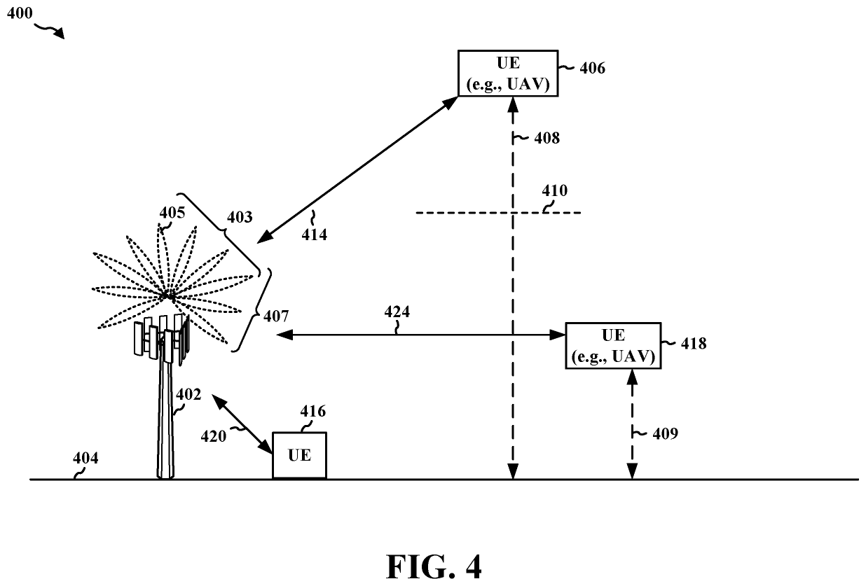

FIG. 4 illustrates an example communication system 400 in which a network node, such as a base station 402, communicates with multiple UEs (e.g., UE 416, 406, and 418) at various heights relative to a ground level 404 (e.g., altitude(s)). FIG. 4 illustrates that UE 406 and UE 418 may be a UAV or may be located at a UAV or other aircraft. In some aspects, the base station 402 may be located at or near a ground level 404, and may also communicate with one or more UEs 416 that are also located at or near the ground level 404. The UE 406 may be located (e.g., traveling or flying) in the air such that the UE 406 is at a height, elevation, or altitude 408 above the ground level 404. The UE 418 may be at the altitude 409. FIG. 4 illustrates that the UE 406 may exchange communication 414 with the base station 402, and the UE 418 may exchange communication 424 with the base station 402. The UE 416 may exchange communication 420 with the base station 402. The base station may transmit communication using one or more directional beams 405, e.g., as described in connection with 182 in FIG. 1. The base station 402 may transmit signals on the beams 405 for the UEs to perform synchronization or other measurements, such as for beam management or mobility. As an example, the base station 402 may transmit SSBs on the beams 405, and the UEs (e.g., 406, 416, and 418) may measure one or more of the SSBs transmitted by the base station 402.

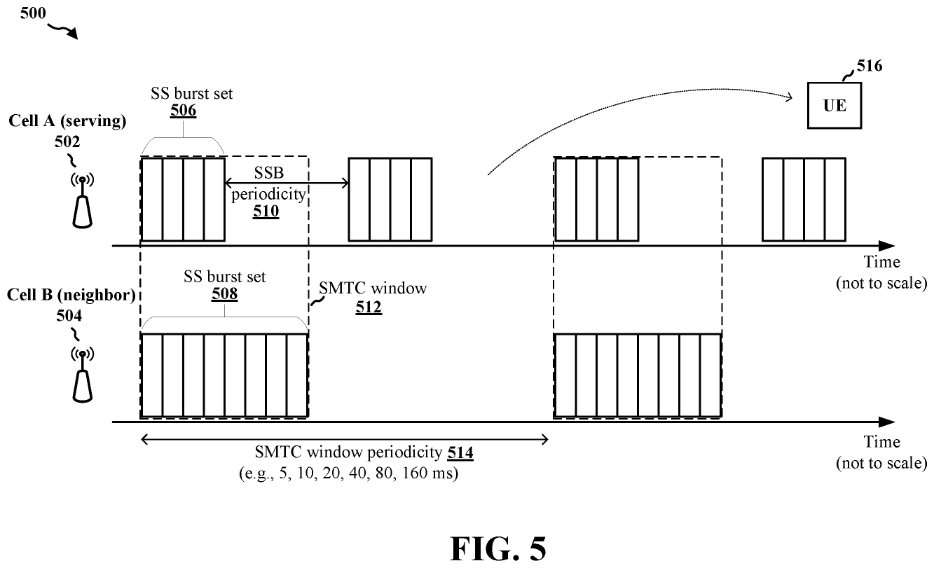

FIG. 5 is a diagram 500 illustrating examples of beam measurements for SSB bursts (e.g., a group of SSB transmissions), in various aspects. A base station may provide a UE with a SSB measurement time configuration (also referred to herein as SMTC) for the UE to utilize in the performance of beam measurements, e.g., for mobility. In aspects, physical broadcast channel (PBCH) block configurations may be analogously implemented.

In the example illustrated for diagram 500, a cell A 502 and a cell B 504 are shown by way of example. The cell A 502 may be a serving cell of, and the cell B 504 may be a neighbor cell of, a UE 516 to which SSBs may be provided/transmitted. As shown, the cell A 502 have four SSBs in an SS burst set 506 with a SSB periodicity 510, and the cell B 504 may have eight SSBs in an SS burst set 508, which are provided/transmitted to the UE 516.

In aspects, the SSB periodicity 510 for the SS burst set 506 may be 5 ms, 10 ms, 20 ms, 40 ms, 80 ms, 160 ms, and/or the like, but when the UE 516 is in a connected mode, the UE 516 may not measure with this periodicity, and the appropriate measurement periodicity may be configured according to the channel conditions. This may avoid unnecessary measurements and save the UE 516 power. An SMTC window 512 with an SMTC window periodicity 514 may be utilized to notify the UE 516 about the periodicity and the timing of the SSBs that the UE 516 may be allowed to use for cell quality measurements, mobility events, etc. The UE 516 may also be allowed not to monitor SSBs outside of the SMTC window 512. Thus, the network (e.g., the cell A 502) may appropriately set the SMTC window 512 and a measurement gap length based on the SSB periodicity 510 of the SSB burst set 506 for corresponding measurement objects (e.g., measObject).

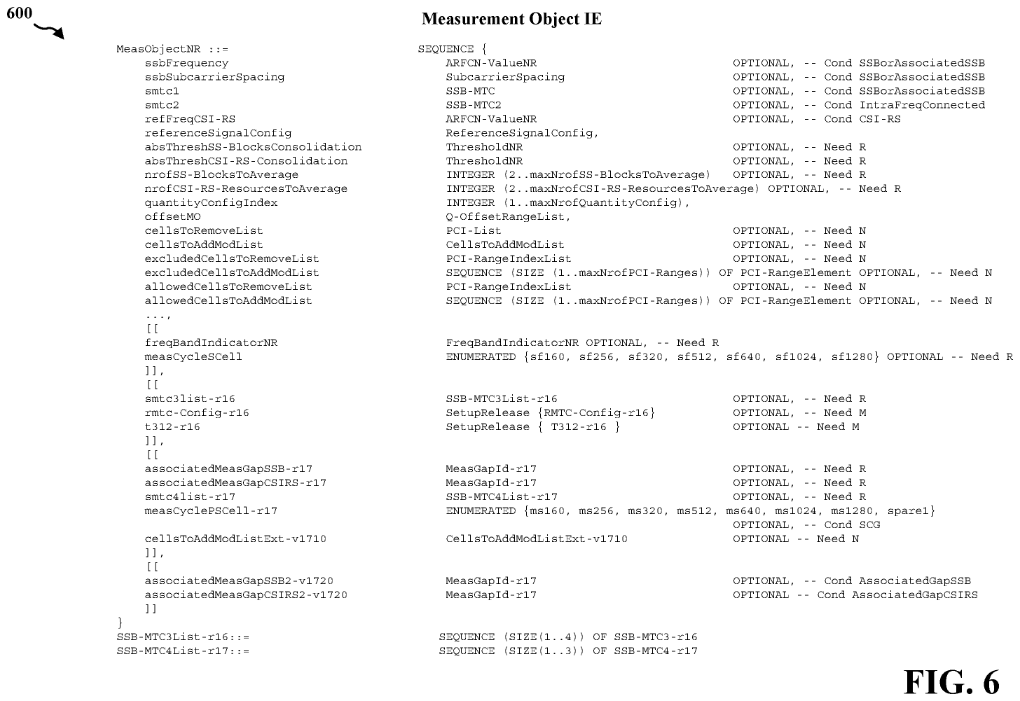

FIG. 6 is a diagram 600 illustrating an example of a measurement object IE for configuring a measurement object for the UE (e.g., such as UE 406, 416, or 418), in various aspects. In aspects, diagram 600 may represent a measurement object IE. In the illustrated aspect, a UE may be configured to setup the first SMTC (also SS/PBCH block measurement timing configuration) in accordance with a received periodicity AndOffset parameter (providing periodicity and offset values for the following condition) in the smtc1 configuration. The first subframe of each SMTC occasion occurs at an system frame number (SFN) and subframe of the SpCell (e.g., a combination of protocols and/or hardware) meeting the following condition:

```
SFN mod T = (FLOOR (Offset/10));
if the Periodicity is larger than sf5:
  subframe = Offset mod 10;
else:
  subframe = Offset or (Offset +5);
with T = CEIL(Periodicity/10).
```

If smtc2 is present, for cells indicated in the pci-List parameter in smtc2 in the same measurement object, the UE may setup an additional SS/PBCH block measurement timing configuration (e.g., SMTC) in accordance with the received periodicity parameter in the smtc2 configuration and use the Offset (derived from parameter periodicity AndOffset) and duration parameter from the smtc1 configuration. The first subframe of each SMTC occasion may occur at an SFN and subframe of the SpCell meeting the above condition.

If smtc2-LP is present, for cells indicated in the PCI list (e.g., pci-List parameter) in smtc2-LP in the same frequency (for intra frequency cell reselection) or different frequency (for inter frequency cell reselection), the UE may setup an additional SS/PBCH block measurement timing configuration (e.g., SMTC) in accordance with the received periodicity parameter in the smtc2-LP configuration and use the Offset (e.g., derived from parameter periodicityAndOffset) and duration parameter from the smtc configuration for that frequency. The first subframe of each SMTC occasion may occur at an SFN and subframe of the SpCell or serving cell (e.g., for cell reselection) meeting the above condition.

If smtc3list is present, for cells indicated in the pci-List parameter in each SSB-MTC3 element of the list in the same measurement object, the IAB-MT antenna may setup an additional SSB measurement timing configuration in accordance with the received periodicity AndOffset parameter (e.g., using same condition as smtel to identify the SFN and the subframe for SMTC occasion) in each SSB-MTC3 configuration and use the duration and ssb-ToMeasure parameters from each SSB-MTC3 configuration.

If smtc4list is present, for cells indicated in the pci-List parameter in each SSB-MTC4 element of the list in the same measurement object, the UE may setup an additional SS/PBCH block measurement timing configuration (e.g., SMTC) in accordance with the received Offset parameter in the smtc4 configuration and use the periodicity (e.g., derived from parameter periodicity AndOffset) and duration parameter from the smtc1 configuration. The first subframe of each SMTC occasion may occur at an SFN and subframe of the SpCell meeting the above condition.

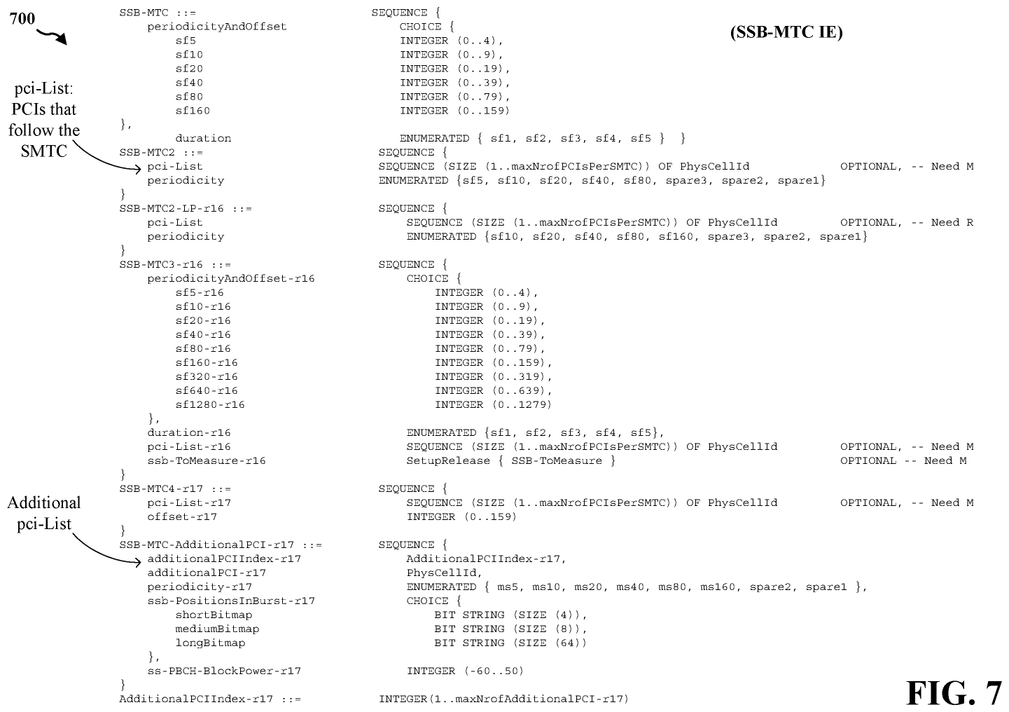

FIG. 7 is a diagram 700 illustrating an example of a MTC IE, in various aspects. In aspects, diagram 700 may represent a SSB-MTC IE. Diagram 700 may be a further aspect of diagram 600 in FIG. 6. In aspects, diagram 700 may represent a SSB-MTC IE. In the illustrated aspect, a UE may be configured to setup a list(s) of physical cell identifiers (PCIs), e.g., a pci-LIST that may follow a given SMTC, such as described for diagram 600, by way of example. Further, an additional list of PCIs may be provided that also follows the SMTC. Yet, this additional list of PCIs may not apply to the measurement object and is a part of additional MIMO parameters in SIB (e.g., for a mTRP use case).

A physical cell (e.g., a serving cell, a neighbor cell(s), etc.) may have multiple beams, and a UE may measure multiple SSBs for mobility, positioning, and/or beam management, e.g., as described in connection with FIG. 4. Configurations for such measurements may include a bitmap (in some aspects, “ssb-ToMeasure”) that indicates a set of SSBs to measure within a SMTC measurement duration. The ssb-ToMeasure may a single bitmap in a SSB-ConfigMobility object and may apply to all measurements in configurations, e.g., “smtc” and “smtc2,” for a given measurement object. However, multiple measurement object configurations for a given SSB frequency (“ssbFrequency”) may not be enabled or allowed for a cell group. For instance, some wireless networks may be implemented to ensure that, in the measurement configuration (“measConfig”) associated with a configured grant (CG): (1) for all SSB based measurements there is at most one measurement object with the same SSB frequency (e.g., which may be referred to as “ssbFrequency”); and/or (2) an “smtc1” included in any measurement object with the same SSB frequency has the same value, and that an smtc2 included in any measurement object with the same SSB frequency has the same value, and that an “smtc3list” included in any measurement object with the same ssbFrequency has the same value, and that an “smtc4list” included in any measurement object with the same SSB frequency has the same value. Yet, for a given altitude range in which the UE is present, additional flexibility for cell-specific beam measurements may improve beam measurements. Aspects herein enable SMTCs with increased flexibility that allow for a UE (e.g., an unmanned aerial vehicle (UAV) or other type of UE) to measure a first set of beams (or (cell, beam) ordered pairs) based on a UE altitude. For example, the UE may measure the first set of beams at one altitude range (e.g., below or level with clutter) and a different set of beams at a different altitude range (e.g., above a certain altitude where line of sight (LOS) is usually expected), including for different cells. As an example, the UE 406 in FIG. 4, may measure a first set of beams (e.g., a subset 403 of the beams 405) based on being above the altitude threshold 410, and the UE 418 may measure a second set of beams (e.g., subset 407 of the beams 405) based on being below the altitude threshold 410.

Various aspects herein for altitude-dependent measurement and reporting configurations improve flexibility and accuracy for positioning and mobility measurements at a UE via configurations of altitude-specific measurements for synchronization signals. By enabling configurations of altitude-specific measurements with altitude ranges/intervals for synchronization signals, various aspects improve flexibility and accuracy for positioning and mobility measurements at a UE for specific synchronization signals based on UE altitude, e.g., for UAVs. Additionally, various aspects provide SSB-MTC sub-configurations where each element of the SSB-MTC lists flexibly allows altitude ranges for flexibility and accuracy for positioning and mobility measurements at a UE for specific synchronization signals based on UE altitude through configurations of altitude-specific measurements with SSB-MTC lists in measurement objects. Aspects herein thus provide for additional flexibility for beam measurements beyond what is provided in current solutions. Aspects herein enable measurement object configurations and/or SMTCs with flexibility that allow for a UE (e.g., a UAV) to measure a first set of beams (or [cell, beam] ordered pairs) at one altitude range (e.g., below or level with clutter) and a different set of beams at a different altitude range (e.g., above a certain altitude where line of sight (LOS) is usually expected), including for different cells and/or of different beams for different altitude ranges/intervals. In aspects, use of the term altitude may be equivalent to a height, an elevation, and/or the like, and may be in the context of a relation to the ground, sea level, or some other reference.

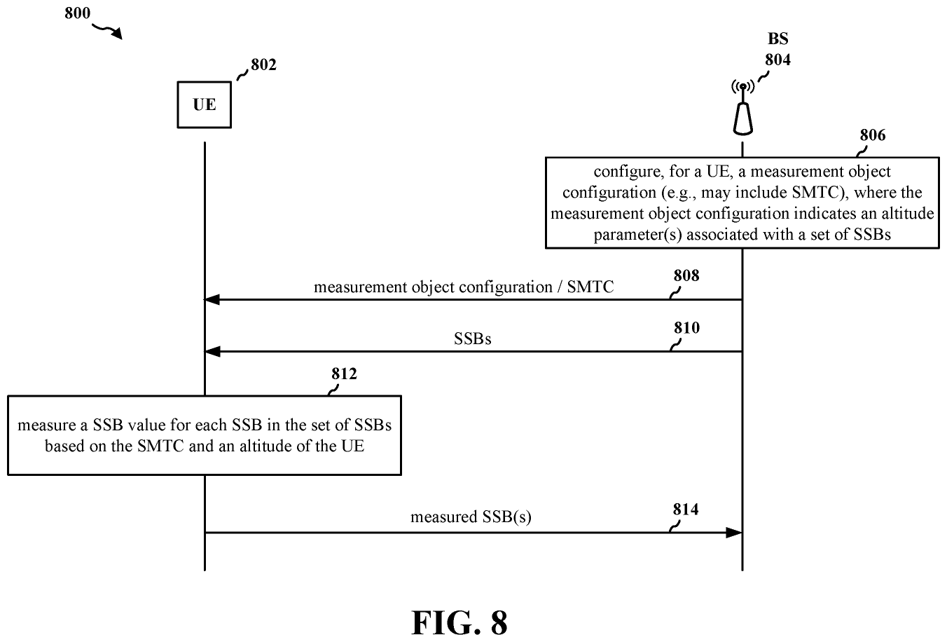

FIG. 8 is a call flow diagram 800 for wireless communications, in various aspects. Call flow diagram 800 illustrates configurations for altitude-dependent measurement and reporting configurations by a UE (e.g., a UE 802) that may communicate with a network node (a base station 804, such as a gNB or other type of base station, by way of example, as shown). Aspects described for the base station 804 may be performed by the base station in aggregated form and/or by one or more components of the base station 804 in disaggregated form. Additionally, or alternatively, the aspects may be performed by the UE 802 autonomously, in addition to, and/or in lieu of, operations of the base station 804. In some aspects, the base station 804 may correspond to the base station 402 in FIG. 4, or may perform similar aspects to the base station 402 in FIG. 4.

In the illustrated aspect, the base station 804 may configure (at 806) a measurement object configuration and/or SMTC 808 for the UE 802, where the measurement object configuration and/or SMTC 808 indicates an altitude parameter(s) (e.g., a minimum altitude value(s), a maximum altitude value(s), a threshold altitude value(s), an altitude range(s), and/or a hysteresis value(s)) for a set(s) of SSBs. In aspects, a given altitude parameter may be associated with at least one cell identifier that correspond to at least one physical cell. In aspects, each altitude range of one or more (e.g., multiple) altitude ranges may be associated with a corresponding set of at least one cell identifier and a corresponding set of SSBs (e.g., a subset of SSBs to be measured from the set of SSBs associated with at least one physical cell that falls within a SMTC window). The SMTC may include any of the aspects described in connection with FIG. 7. In aspects, the measurement object configuration and/or SMTC 808 may include an added altitude-specific flexibility to a measurement object through indications of altitude-specific SSB(s) to measure. In aspects, this newly-added altitude-specific flexibility for measurement objects may be implemented for existing measurement objects. In aspects, new configurations for the measurement object configuration and/or SMTC 808 may include altitude ranges/intervals. In one example, different SSBs to measure (e.g., ssb-ToMeasure) for different altitude ranges/intervals may be included for an SSB-MTC configuration of the measurement object configuration and/or SMTC 808. In another example, a new SSB-MTC list may be included in a measurement object, where each element of the new SSB-MTC list may represent a SSB-MTC sub-configuration with a respective altitude range(s)/interval(s). In aspects, a hysteresis value, which may define a hysteresis range, may be associated with an altitude range/interval boundary. The base station 804 may be configured to provide/transmit the measurement object configuration and/or SMTC 808 for the UE 802.

The base station 804 may also be configured to provide/transmit the set of SSBs for the UE 802. The base station 804 may be a service/serving cell or a neighboring cell, in aspects, and may be configured to transmit a number of SSBs 810 for the UE 802 that includes the set of SSBs indicated in the measurement object configuration and/or SMTC 808. In aspects, different base stations may be configured to transmit different numbers of the SSBs 810 to the UE 802. A cell may be a physical cell with a corresponding PCI. In aspects, at least one physical cell in an environment of the UE 802 may be a service/serving cell, and the measurement object configuration and/or SMTC 808 may be a cell-specific SMTC for the service/serving cell. In some aspects, at least one physical cell in an environment of the UE 802 may include two or more physical cells (e.g., a service/serving cell and a neighbor cell), and the measurement object configuration and/or SMTC 808 may configure the UE 802 for the physical cells, respectively, as described herein.

A UE may be configured to obtain the altitude of the UE, e.g., by being configured to measure the altitude of the UE based on information received by the UE or to receive an indication of the altitude of the UE from the network node or a network entity. The UE 802 may be configured to obtain the altitude of the UE 802. In aspects, to obtain the altitude, the UE 802 may be configured to measure (at 812) the altitude of the UE 802 based on information received by the UE 802 and/or receive an indication of the altitude of the UE 802 from the network node or a network entity (e.g., the base station 804). The base station 804 may be configured to obtain the altitude of the UE 802. In aspects, to obtain the altitude, the base station 804 may be configured to measure (similarly to 812) the altitude of the UE 802 based on information received from the UE 802 or from another network node/entity. The base station 804 may be configured to provide an indication of the altitude of the UE 802 to the UE 802. The altitude of the UE 802 may be quantified with respect to ground, sea level, clutter, and/or the like. The UE 802 may be configured to measure (at 812) a SSB value for each SSB in the set of SSBs (e.g., from the number of the SSBs 810 provided/transmitted from the base station 804), which may be for the at least one physical cell in aspects (e.g., a set of SSBs associated with one or more physical cells, such as during an SMTC window), based on the measurement object configuration and/or SMTC 808 and an altitude of the UE 802.

The UE 802 may be configured to report, e.g., for the base station 804, each measured SSB(s) 814 in the set of SSBs (e.g., from the number of the SSBs 810 provided/transmitted from the base station 804) for the at least one physical cell at the altitude of the UE 802, based on a reporting configuration that is associated with the altitude of the UE 802, and at least one of the altitude, a location, a velocity, or a speed of the UE 802. In aspects, the UE 802 may be configured to report each measured SSB(s) 814 to the base station 804.

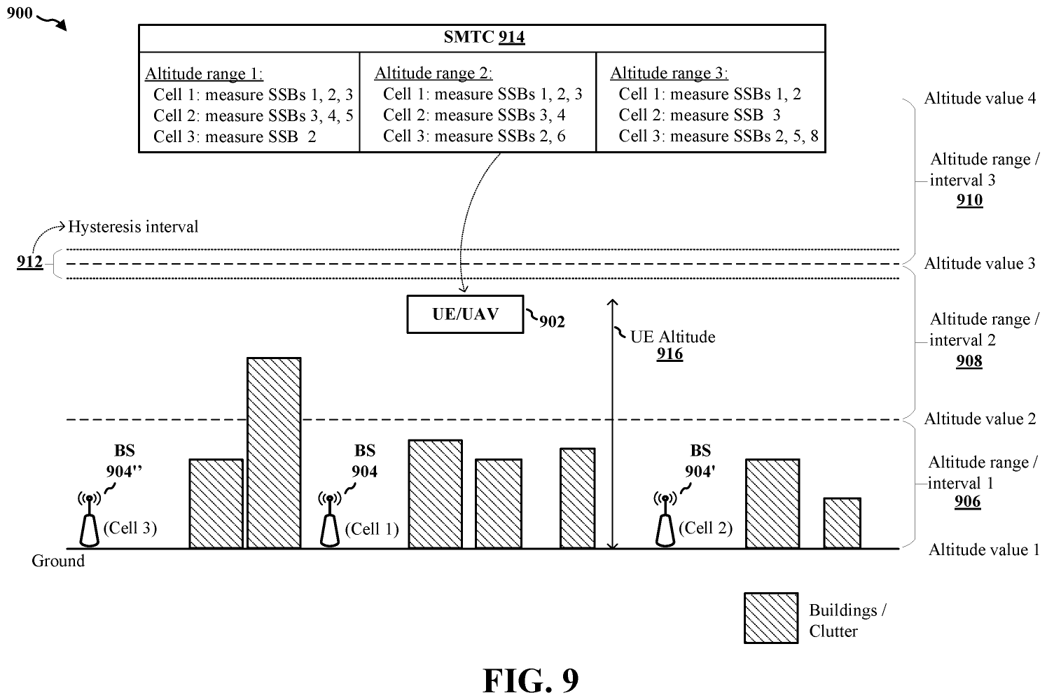

As noted, aspects herein provide for additional flexibility for beam measurements beyond what is provided in current solutions. Aspects herein enable SMTCs with flexibility that allow for a UE (e.g., a UAV) to measure a first set of beams (or [cell, beam] ordered pairs) at one altitude range (e.g., below or level with clutter) and a different set of beams at a different altitude range (e.g., above a certain altitude where LOS is usually expected), including for different cells and/or of different beams for different altitude ranges/intervals. In this context, and with reference to FIG. 8 described above, FIGS. 9-11 are described below.

FIG. 9 is a diagram 900 illustrating example configurations for altitude-dependent measurement and reporting, in various aspects. Diagram 900 shows a UE 902 (which may be, or may be associated with, a UAV) that may be configured to communicate with network nodes/base stations (e.g., a gNB). For example, diagram 900 includes a first base station 904 (e.g., a service/serving base station) of a first physical cell (Cell 1), a second base station 904′ (e.g., a neighbor base station) of a second physical cell (Cell 2), and a third base station 904″ (e.g., a neighbor base station) of a third physical cell (Cell 3). The base stations may perform any of the aspects described in connection with the base station 402 or 804. The aspects described in connection with FIG. 9 may be performed by the base station 402 or 804. The aspects illustrated in diagram 900 may be for altitude-dependent measurement and reporting configurations (e.g., via SMTC) of the UE 902, as described herein.

Diagram 900 illustrates a SMTC 914 that configures the UE 902 for three different altitude ranges/intervals, by way of example: an altitude range 906, an altitude range 908, and an altitude range 910. Although aspects are described for ranges or intervals, the aspects may also be applied using one or more altitude thresholds. As shown for the SMTC 914, altitude range 1 (e.g., altitude range 906) indicates that for Cell 1, the UE 902 should measure SSBs 1, 2, 3; for Cell 2, the UE 902 should measure SSBs 3, 4, 5; and for Cell 3, the UE 902 should measure SSB 2. As shown for the SMTC 914, altitude range 2 (e.g., altitude range 908) indicates that for Cell 1, the UE 902 should measure SSBs 1, 2, 3; for Cell 2, the UE 902 should measure SSBs 3, 4; and for Cell 3, the UE 902 should measure SSBs 2, 6. As shown for the SMTC 914, altitude range 3 (e.g., altitude range 910) indicates that for Cell 1, the UE 902 should measure SSBs 1, 2; for Cell 2, the UE 902 should measure SSB 3; and for Cell 3, the UE 902 should measure SSBs 2, 5, 8.

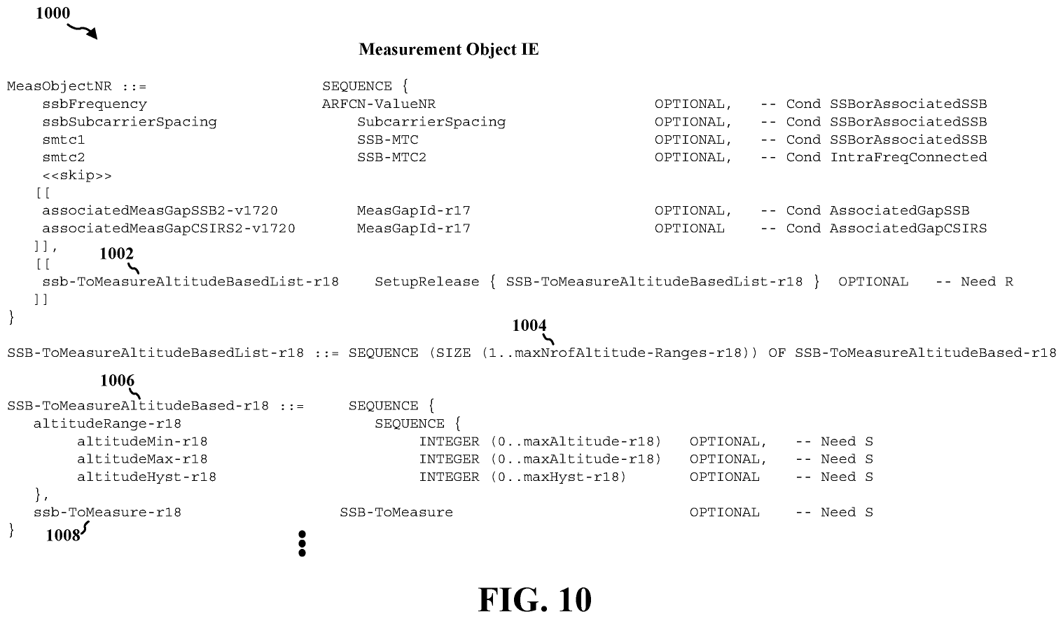

The altitude range 906, the altitude range 908, and/or the altitude range 910 may be defined or bounded by a minimum altitude value and/or a maximum altitude value, as described herein (e.g., with respect to FIGS. 10-12 described below). In aspects, where a minimum altitude value is not specified, it may default to zero (or another pre-configured value); where a maximum altitude value is not specified, it may default to infinity (or another pre-configured value). In the illustrated example of diagram 900, the a minimum altitude value may be an altitude value 1 (e.g., the ground) and the maximum altitude value may be an altitude value 2 for the altitude range 906 (e.g., an altitude range below or level with clutter such as building and/or other structures). In the illustrated example of diagram 900, the a minimum altitude value may be the altitude value 2 and the maximum altitude value may be an altitude value 3 for the altitude range 908 (e.g., an altitude range above most clutter such as building and/or other structures where LOS may be present). In the illustrated example of diagram 900, the a minimum altitude value may be the altitude value 3 and the maximum altitude value may be an altitude value 4 for the altitude range 910 (e.g., an altitude range above clutter such as building and/or other structures where LOS may be usually expected).

In aspects, boundaries of the altitude range 906, the altitude range 908, and/or the altitude range 910 may be associated with a hysteresis value that defines a hysteresis interval 912. That is, when traversing or operating at a UE altitude 916 near a boundary of an altitude range/interval, the UE 902 may switch to a configuration for an adjacent altitude range/interval once outside of the hysteresis interval 912, which may reduce or eliminate “ping-pong” or oscillation between different configurations and save power/provide consistent measurements for the UE 902. In aspects, the hysteresis value may be a number of units of length (e.g., 1 m, 2 m, etc.), a percentage of an altitude range/interval (e.g., 0.1%, 1%, 5%, etc.) and/or the like.

Aspects presented herein contemplate any number of altitude ranges, SSBs to measure, physical cells, hysteresis intervals/values, etc., and that the illustrated aspects are provided by way of example.

FIG. 10 is a diagram 1000 illustrating an example configuration for altitude-dependent measurement and reporting, in various aspects. The configuration may be provided to the UE 802 at 808, for example. As noted herein, a SMTC may include an added altitude-specific flexibility to a measurement object (e.g., which may be a measObjectNR or other measurement object) through indications of altitude-specific SSB(s) to measure. Diagram 1000 shows a portion of an SMTC (e.g., a measurement object IE) in which altitude-specific SSB(s) to measure are included for a UE.

For instance, aspects provide that a measurement object of a SMTC may include indications of altitude-specific SSB(s) to measure 1002. The indication of the altitude-specific SSB(s) to measure 1002 may reference a number of altitude ranges 1004 for which a SMTC may configure a UE for one or more specific SSBs that are to be measured by the UE. Each SSB to measure 1008 may be provided an IE 1006 associated with an altitude range. The altitude range may be based on at least one of a minimum altitude value or a maximum altitude value. In aspects, where a minimum altitude value is not specified, it may default to zero (or another pre-configured value); where a maximum altitude value is not specified, it may default to infinity (or another pre-configured value). In aspects, a hysteresis value, which may define a hysteresis range and be associated with an altitude range/interval boundary, may be included in the IE 1006 for a given one of the SSB to measure 1008. In some aspects, multiple ones of the IE 1006 for corresponding ones of the SSB to measure 1008 may be included for a measurement object of a SMTC.

Accordingly, aspects herein for altitude-dependent measurement and reporting configurations improve flexibility and accuracy for positioning and mobility measurements at a UE via configurations of altitude-specific measurements for synchronization signals. By enabling configurations of altitude-specific measurements with altitude ranges/intervals for synchronization signals, various aspects improve flexibility and accuracy for positioning and mobility measurements at a UE for specific synchronization signals based on UE altitude, e.g., for UAVs.

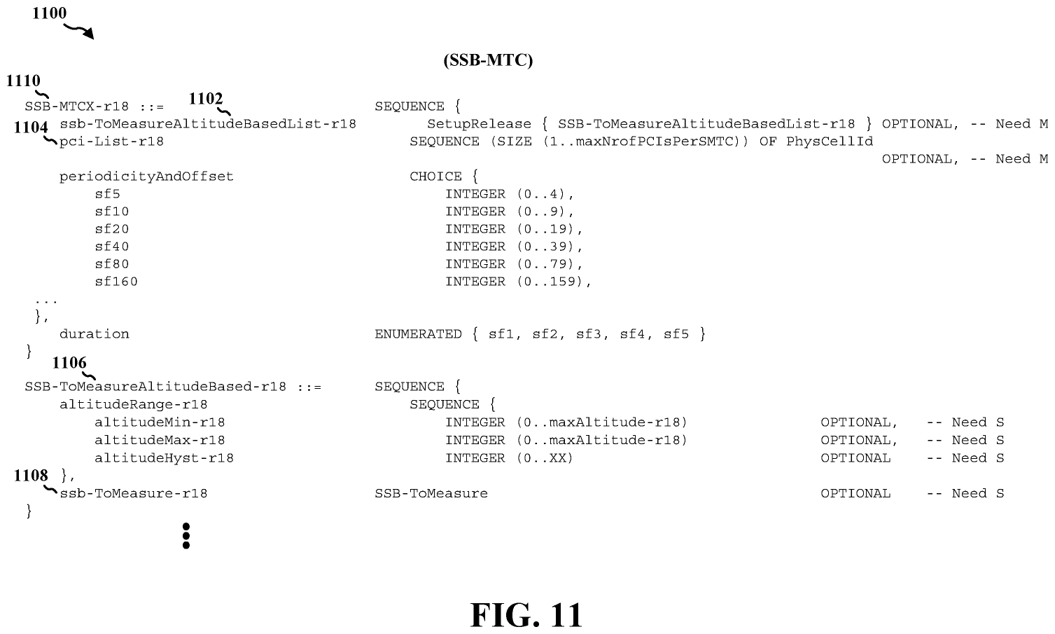

FIG. 11 is a diagram 1100 illustrating an example configuration for altitude-dependent measurement and reporting, in various aspects. The configuration may be provided to the UE 802 at 808, for example. In aspects, new configurations for a SMTC may include altitude ranges/intervals. In one example, different SSBs to measure (e.g., ssb-ToMeasure) for different altitude ranges/intervals may be included for an SSB-MTC configuration of a SMTC. Diagram 1100 shows a portion of an SMTC (e.g., a SSB-MTC object 1110) in which altitude-specific SSB(s) to measure 1102 are included for a UE.

For instance, aspects for diagram 1100 provide that a SMTC may include indications of the altitude-specific SSB(s) to measure 1102 (e.g., SSB-ToMeasureAltitudeBasedList-r18) in the SSB-MTC object 1110. The altitude-specific SSB(s) to measure 1102 may include a list of altitude-dependent SSBs for measurement (e.g., which may be referred to as “ssb-ToMeasure” in some examples). When a UE is within an altitude range indicated by a height range parameter (e.g., which may be referred to as a “heightRange” or “altitude Range” in some examples), the UE may ignore the ssb-ToMeasure (e.g., without suffix), and may apply the corresponding ssb-ToMeasure-r18 if present; otherwise the UE may measure on all SS-blocks if ssb-ToMeasure-r18 is absent. When the UE is outside all the altitude ranges (e.g., height ranges) indicated by altitude Range (if any), ssb-ToMeasure (e.g., without suffix) may apply. For each altitude range, a minimum altitude parameter (e.g., which may be referred to as “heightMin” or “altitudeMin” in some examples) may indicate the minimum altitude in meters, an altitude maximum parameter (e.g., which may be referred as “heightMax” or “altitudeMax” in some examples) may indicate the maximum altitude in meters relative to sea level, and if included, a parameter that may be referred to as a “heightHyst” or “altitudeHyst” may indicate hysteresis (e.g., in distance such as meters) for determination of the altitude range. For instance, when altitudeHyst is configured for an altitude range, the UE may consider itself to have entered the range if altitudeMin≤UE altitude≤altitudeMax and after entering the range, the UE may consider itself to be in the range while (altitude Min altitudeHyst)≤UE altitude≤(altitudeMax+altitude Hyst). For each altitudeRange, if altitudeMin is absent, the value minAltitude-r18 may be used, and if altitudeMax is absent, the value maxAltitude-r18 may be used.

The altitude-specific SSB(s) to measure 1102 may be associated with a list of one or more PCIs 1104 of corresponding physical cells for which a SMTC may configure a UE for one or more specific SSBs that are to be measured by the UE. Each SSB to measure 1108 may be provided an IE 1106 associated with an altitude range (e.g., SSB-ToMeasureAltitudeBased-r18). The altitude range may be based on at least one of a minimum altitude value or a maximum altitude value. In aspects, where a minimum altitude value is not specified, it may default to zero (or another pre-configured value); where a maximum altitude value is not specified, it may default to infinity (or another pre-configured value). In aspects, a hysteresis value, which may define a hysteresis range and be associated with an altitude range/interval boundary, may be included in the IE 1106 for a given one of the SSB to measure 1108. In some aspects, multiple ones of the IE 1106 for corresponding ones of the SSB to measure 1108 may be included for the SSB-MTC object 1110 of a SMTC.

Accordingly, aspects herein for altitude-dependent measurement and reporting configurations improve flexibility and accuracy for positioning and mobility measurements at a UE via configurations of altitude-specific measurements for synchronization signals. By providing SSB-MTC sub-configurations where each element of the SSB-MTC lists, altitude ranges are enabled for flexibility and accuracy for positioning and mobility measurements at a UE for specific synchronization signals based on UE altitude through configurations of altitude-specific measurements with SSB-MTC lists in measurement objects.

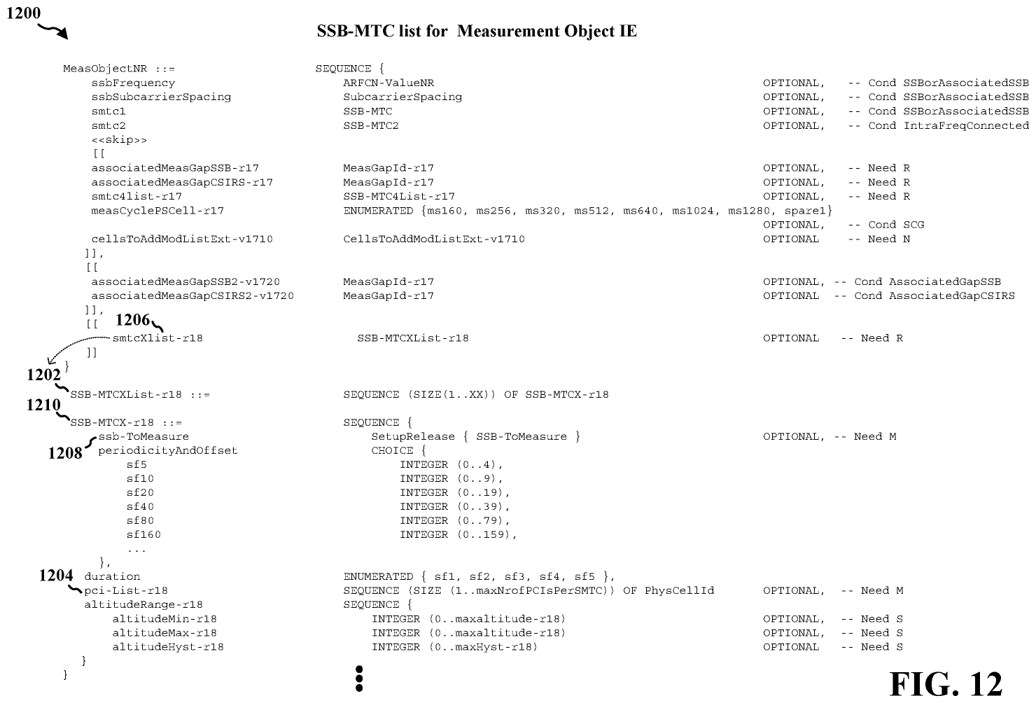

FIG. 12 is a diagram 1200 illustrating an example configuration for altitude-dependent measurement and reporting, in various aspects. In aspects, new configurations for a SMTC may include altitude ranges/intervals. The configuration may be provided to the UE 802 at 808, for example. In one example, a SMTC list 1206 may be included in a measurement object (e.g., measObjectNR or other measurement object), where the SMTC list 1206 references a new SSB-MTC list 1202. Each element of the new SSB-MTC list 1202 may represent a SSB-MTC sub-configuration with a respective altitude range(s)/interval(s) for an SSB to measure 1208.

For instance, aspects for diagram 1200 provide that a SMTC may include indications of altitude-specific SSB(s) to measure in the new SSB-MTC list 1202 which in turn references a SSB-MTC object 1210. Each SSB-MTC object 1210 may be associated with a list of one or more PCIs 1204 of corresponding physical cells for which a SMTC may configure a UE for one or more specific SSBs that are to be measured by the UE. Each SSB to measure 1208 may be provided respective ones of the SSB-MTC object 1210 associated with an altitude range. The altitude range may be based on at least one of a minimum altitude value or a maximum altitude value. In aspects, where a minimum altitude value is not specified, it may default to zero (or another pre-configured value); where a maximum altitude value is not specified, it may default to infinity (or another pre-configured value). In aspects, a hysteresis value, which may define a hysteresis range and be associated with an altitude range/interval boundary, may be included in the SSB-MTC object 1210 for a given one of the SSB to measure 1208. In some aspects, multiple ones of the SSB-MTC object 1210 for corresponding ones of the SSB to measure 1208 may be included for a SMTC, while in other aspects, multiple ones of the SSB to measure 1208 may be included for the SSB-MTC object 1210 of a SMTC.

Accordingly, aspects herein for altitude-dependent measurement and reporting configurations improve flexibility and accuracy for positioning and mobility measurements at a UE via configurations of altitude-specific measurements for synchronization signals. By providing SSB-MTC sub-configurations where each element of the SSB-MTC lists, altitude ranges are enabled for flexibility and accuracy for positioning and mobility measurements at a UE for specific synchronization signals based on UE altitude through configurations of altitude-specific measurements with SSB-MTC lists in measurement objects.

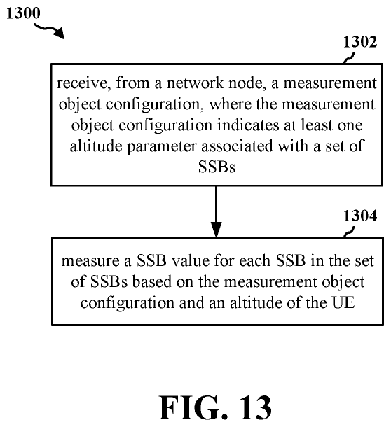

FIG. 13 is a flowchart 1300 of a method of wireless communication, in various aspects. The method may be performed by a UE (e.g., the UE 104, 406, 416, 418, 516, 802, 902; the apparatus 1704). In some aspects, the method may include aspects described in connection with the communication flow in FIG. 8 and/or aspects described in FIG. 4 or 9-12. The method provides for altitude-dependent measurement and reporting configurations that enable improvements for flexibility and accuracy for positioning and mobility measurements at a UE via configurations of altitude-specific measurements for synchronization signals. By enabling configurations of altitude-specific measurements with altitude ranges/intervals for synchronization signals, various aspects improve flexibility and accuracy for positioning and mobility measurements at a UE for specific synchronization signals based on UE altitude, e.g., for UAVs.

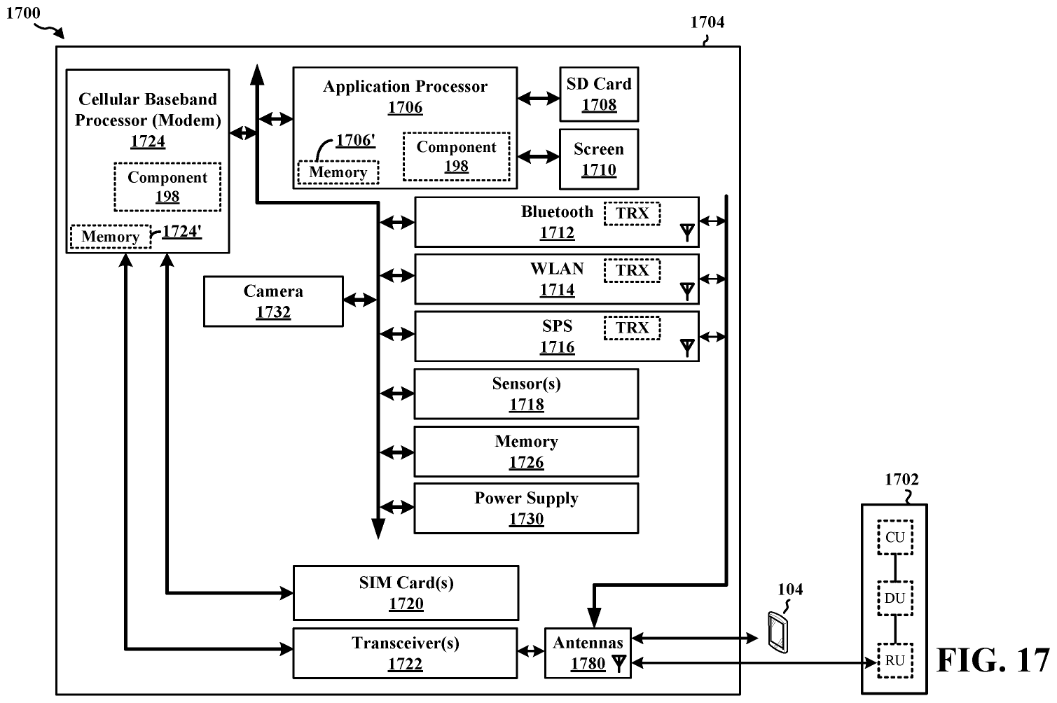

At 1302, a UE receives, from a network node, a SMTC, where the SMTC indicates an altitude range associated with a set of SSBs and at least one cell identifier, that correspond to at least one physical cell. As an example, the transmission may be performed, at least in part, by the component 198, the transceiver(s) 1722, and/or the antenna 1780 in FIG. 17. FIGS. 8-12 illustrate an example of the UE 802 receiving such a SMTC from a network node (e.g., the base station 804).

The base station 804 may configure (at 806) a SMTC 808 (e.g., 914 in FIG. 9; 1000 in FIG. 10; 1100 in FIG. 11; 1200 in FIG. 12) for the UE 802, where the SMTC 808 (e.g., 914 in FIG. 9; 1000 in FIG. 10; 1100 in FIG. 11; 1200 in FIG. 12) indicates an altitude range (or altitude parameter) (e.g., 906, 908, 910 in FIG. 9; for 1006 in FIG. 10; for 1106 in FIG. 11; for 1210 in FIG. 12) associated with at least one cell identifier that correspond to at least one physical cell (e.g., 904 (Cell 1), 904′ (Cell 2), 904″ (Cell 3), in FIG. 9; 1104 in FIG. 11; 1208 in FIG. 12), and a set of SSBs (e.g., in 914 in FIG. 9; 1008 in FIG. 10; 1108 in FIG. 11; 1208 in FIG. 12). In aspects, the SMTC 808 (e.g., 914 in FIG. 9; 1000 in FIG. 10; 1100 in FIG. 11; 1200 in FIG. 12) may include an added altitude-specific flexibility to a measurement object (e.g., measObjectNR) through indications of altitude-specific SSB(s) to measure (e.g., in 914 in FIG. 9; 1008 in FIG. 10; 1108 in FIG. 11; 1208 in FIG. 12). In aspects, this newly-added altitude-specific flexibility for measurement objects may be implemented for existing measObjectNR measurement objects. In aspects, new configurations for the SMTC 808 (e.g., 914 in FIG. 9; 1000 in FIG. 10; 1100 in FIG. 11; 1200 in FIG. 12) may include altitude ranges/intervals (e.g., 906, 908, 910 in FIG. 9; for 1006 in FIG. 10; for 1106 in FIG. 11; for 1210 in FIG. 12). In one example, different SSBs to measure (e.g., ssb-ToMeasure) for different altitude ranges/intervals (e.g., 906, 908, 910 in FIG. 9; for 1006 in FIG. 10; for 1106 in FIG. 11; for 1210 in FIG. 12) may be included for an SSB-MTC configuration (e.g., 1110 in FIG. 11; 1210 in FIG. 12) of the SMTC 808 (e.g., 914 in FIG. 9; 1000 in FIG. 10; 1100 in FIG. 11; 1200 in FIG. 12). In another example, a new SSB-MTC list (e.g., 1202 in FIG. 12) may be included in a measurement object (e.g., measObjectNR), where each element of the new SSB-MTC list (e.g., 1202 in FIG. 12) may represent a SSB-MTC sub-configuration with a respective altitude range(s)/interval(s) (e.g., 906, 908, 910 in FIG. 9; for 1006 in FIG. 10; for 1106 in FIG. 11; for 1210 in FIG. 12). In aspects, a hysteresis value, which may define a hysteresis range (e.g., 912 in FIG. 9; for 1006 in FIG. 10; for 1106 in FIG. 11; for 1210 in FIG. 12), may be associated with an altitude range/interval boundary (e.g., 906, 908, 910 in FIG. 9; for 1006 in FIG. 10; for 1106 in FIG. 11; for 1210 in FIG. 12). The base station 804 may be configured to provide/transmit the SMTC 808 (e.g., 914 in FIG. 9; 1000 in FIG. 10; 1100 in FIG. 11; 1200 in FIG. 12) for the UE 802.

At 1304, the UE measures a SSB value for each SSB in the set of SSBs based on the measurement object configuration and an altitude of the UE. As an example, the measurement may be performed, at least in part, by the component 198, the transceiver(s) 1722, and/or the antenna 1780 in FIG. 17. FIGS. 8-12 illustrate an example of the UE 802 measuring such SSB values for SSBs from a network node (e.g., the base station 804). FIG. 8 illustrates an example of a UE measuring a subset of SSBs based on an altitude of the UE.

The base station 804 may also be configured to provide/transmit the set of SSBs (e.g., in 914 in FIG. 9; 1008 in FIG. 10; 1108 in FIG. 11; 1208 in FIG. 12) for the UE 802. The base station 804 may be a service/serving cell or a neighboring cell, in aspects, and may be configured to transmit a number of SSBs 810 (e.g., in 914 in FIG. 9; 1008 in FIG. 10; 1108 in FIG. 11; 1208 in FIG. 12) for the UE 802 that includes the set of SSBs (e.g., in 914 in FIG. 9; 1008 in FIG. 10; 1108 in FIG. 11; 1208 in FIG. 12) indicated in the SMTC 808 (e.g., 914 in FIG. 9; 1000 in FIG. 10; 1100 in FIG. 11; 1200 in FIG. 12). In aspects, different base stations may be configured to transmit different numbers of the SSBs 810 (e.g., in 914 in FIG. 9; 1008 in FIG. 10; 1108 in FIG. 11; 1208 in FIG. 12) to the UE 802. A cell may be a physical cell with a corresponding PCI (e.g., 904 (Cell 1), 904′ (Cell 2), 904″ (Cell 3), in FIG. 9; 1104 in FIG. 11; 1208 in FIG. 12). In aspects, at least one physical cell (e.g., 904 (Cell 1), 904′ (Cell 2), 904″ (Cell 3), in FIG. 9; 1104 in FIG. 11; 1208 in FIG. 12) in an environment of the UE 802 may be a service/serving cell, and the SMTC 808 (e.g., 914 in FIG. 9; 1000 in FIG. 10) may be a cell-specific SMTC for the service/serving cell. In some aspects, at least one physical cell (e.g., 904 (Cell 1), 904′ (Cell 2), 904″ (Cell 3), in FIG. 9; 1104 in FIG. 11; 1208 in FIG. 12) in an environment of the UE 802 may include two or more physical cells (e.g., a service/serving cell and a neighbor cell) (e.g., 904 (Cell 1), 904′ (Cell 2), 904″ (Cell 3), in FIG. 9; 1104 in FIG. 11; 1208 in FIG. 12), and the SMTC 808 (e.g., 914 in FIG. 9; 1000 in FIG. 10; 1100 in FIG. 11; 1200 in FIG. 12) may configure the UE 802 for the physical cells (e.g., 904 (Cell 1), 904′ (Cell 2), 904″ (Cell 3), in FIG. 9; 1104 in FIG. 11; 1208 in FIG. 12), respectively, as described herein.

The UE 802 may be configured to obtain the altitude of the UE 802. In aspects, to obtain the altitude, the UE 802 may be configured to measure (at 812) the altitude of the UE 802 based on information received by the UE 802 and/or receive an indication of the altitude of the UE 802 from the network node or a network entity (e.g., the base station 804). The altitude of the UE 802 may be quantified with respect to ground, sea level, clutter, and/or the like. The UE 802 may be configured to measure (at 812) a SSB value for each SSB (e.g., in 914 in FIG. 9; 1008 in FIG. 10; 1108 in FIG. 11; 1208 in FIG. 12) in the set of SSBs (e.g., from the number of the SSBs 810 provided/transmitted from the base station 804) for the at least one physical cell (e.g., 904 (Cell 1), 904′ (Cell 2), 904″ (Cell 3), in FIG. 9; 1104 in FIG. 11; 1208 in FIG. 12) based on the SMTC 808 (e.g., 914 in FIG. 9; 1000 in FIG. 10; 1100 in FIG. 11; 1200 in FIG. 12) and an altitude of the UE 802.

The UE 802 may be configured to report, e.g., for the base station 804, each measured SSB(s) 814 (e.g., in 914 in FIG. 9; 1008 in FIG. 10; 1108 in FIG. 11; 1208 in FIG. 12) in the set of SSBs (e.g., from the number of the SSBs 810 provided/transmitted from the base station 804) for the at least one physical cell (e.g., 904 (Cell 1), 904′ (Cell 2), 904″ (Cell 3), in FIG. 9; 1104 in FIG. 11; 1208 in FIG. 12) at the altitude of the UE 802, based on a reporting configuration that is associated with the altitude of the UE 802, and at least one of the altitude, a location, a velocity, or a speed of the UE 802. In aspects, the UE 802 may be configured to report each measured SSB(s) 814 (e.g., in 914 in FIG. 9; 1008 in FIG. 10; 1108 in FIG. 11; 1208 in FIG. 12) to the base station 804.

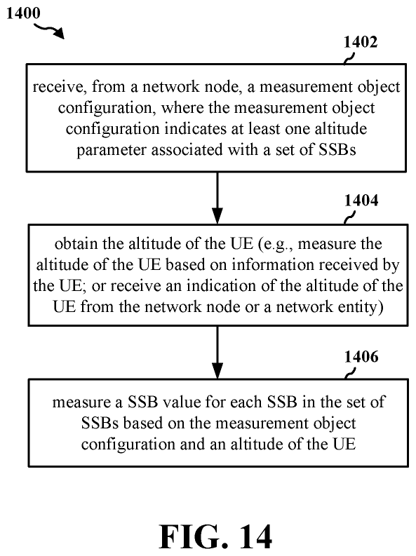

FIG. 14 is a flowchart 1400 of a method of wireless communication, in various aspects. The method may be performed by a UE (e.g., the UE 104, 406, 416, 418, 516, 802, 902; the apparatus 1704). In some aspects, the method may include aspects described in connection with the communication flow in FIG. 8 and/or aspects described in FIG. 4 or 9-12. The method provides for altitude-dependent measurement and reporting configurations that enable improvements for flexibility and accuracy for positioning and mobility measurements at a UE via configurations of altitude-specific measurements for synchronization signals. By enabling configurations of altitude-specific measurements with altitude ranges/intervals for synchronization signals, various aspects improve flexibility and accuracy for positioning and mobility measurements at a UE for specific synchronization signals based on UE altitude, e.g., for UAVs.

At 1402, a UE receives, from a network node, a SMTC, where the SMTC indicates an altitude range associated with a set of SSBs and at least one cell identifier, that correspond to at least one physical cell. As an example, the transmission may be performed, at least in part, by the component 198, the transceiver(s) 1722, and/or the antenna 1780 in FIG. 17. FIGS. 8-12 illustrate an example of the UE 802 receiving such a SMTC from a network node (e.g., the base station 804).

The base station 804 may configure (at 806) a SMTC 808 (e.g., 914 in FIG. 9; 1000 in FIG. 10; 1100 in FIG. 11; 1200 in FIG. 12) for the UE 802, where the SMTC 808 (e.g., 914 in FIG. 9; 1000 in FIG. 10; 1100 in FIG. 11; 1200 in FIG. 12) indicates an altitude range (or altitude parameter) (e.g., 906, 908, 910 in FIG. 9; for 1006 in FIG. 10; for 1106 in FIG. 11; for 1210 in FIG. 12) associated with at least one cell identifier that correspond to at least one physical cell (e.g., 904 (Cell 1), 904′ (Cell 2), 904″ (Cell 3), in FIG. 9; 1104 in FIG. 11; 1208 in FIG. 12), and a set of SSBs (e.g., in 914 in FIG. 9; 1008 in FIG. 10; 1108 in FIG. 11; 1208 in FIG. 12). In aspects, the SMTC 808 (e.g., 914 in FIG. 9; 1000 in FIG. 10; 1100 in FIG. 11; 1200 in FIG. 12) may include an added altitude-specific flexibility to a measurement object (e.g., measObjectNR) through indications of altitude-specific SSB(s) to measure (e.g., in 914 in FIG. 9; 1008 in FIG. 10; 1108 in FIG. 11; 1208 in FIG. 12). In aspects, this newly-added altitude-specific flexibility for measurement objects may be implemented for existing measObjectNR measurement objects. In aspects, new configurations for the SMTC 808 (e.g., 914 in FIG. 9; 1000 in FIG. 10; 1100 in FIG. 11; 1200 in FIG. 12) may include altitude ranges/intervals (e.g., 906, 908, 910 in FIG. 9; for 1006 in FIG. 10; for 1106 in FIG. 11; for 1210 in FIG. 12). In one example, different SSBs to measure (e.g., ssb-ToMeasure) for different altitude ranges/intervals (e.g., 906, 908, 910 in FIG. 9; for 1006 in FIG. 10; for 1106 in FIG. 11; for 1210 in FIG. 12) may be included for an SSB-MTC configuration (e.g., 1110 in FIG. 11; 1210 in FIG. 12) of the SMTC 808 (e.g., 914 in FIG. 9; 1000 in FIG. 10; 1100 in FIG. 11; 1200 in FIG. 12). In another example, a new SSB-MTC list (e.g., 1202 in FIG. 12) may be included in a measurement object (e.g., measObjectNR), where each element of the new SSB-MTC list (e.g., 1202 in FIG. 12) may represent a SSB-MTC sub-configuration with a respective altitude range(s)/interval(s) (e.g., 906, 908, 910 in FIG. 9; for 1006 in FIG. 10; for 1106 in FIG. 11; for 1210 in FIG. 12). In aspects, a hysteresis value, which may define a hysteresis range (e.g., 912 in FIG. 9; for 1006 in FIG. 10; for 1106 in FIG. 11; for 1210 in FIG. 12), may be associated with an altitude range/interval boundary (e.g., 906, 908, 910 in FIG. 9; for 1006 in FIG. 10; for 1106 in FIG. 11; for 1210 in FIG. 12). The base station 804 may be configured to provide/transmit the SMTC 808 (e.g., 914 in FIG. 9; 1000 in FIG. 10; 1100 in FIG. 11; 1200 in FIG. 12) for the UE 802.

At 1404, the UE obtains the altitude of the UE. As an example, the measurement may be performed, at least in part, by the component 198, the transceiver(s) 1722, and/or the antenna 1780 in FIG. 17. FIGS. 8-12 illustrate an example of the UE 802 obtaining such altitude indications. FIG. 8 illustrates an example of a UE measuring a subset of SSBs based on an altitude of the UE.

A UE may be configured to obtain the altitude of the UE, e.g., by being configured to measure the altitude of the UE based on information received by the UE or to receive an indication of the altitude of the UE from the network node or a network entity. The UE 802 may be configured to obtain the altitude of the UE 802. In aspects, to obtain the altitude, the UE 802 may be configured to measure (at 812) the altitude of the UE 802 based on information received by the UE 802 and/or receive an indication of the altitude of the UE 802 from the network node or a network entity (e.g., the base station 804). The base station 804 may be configured to obtain the altitude of the UE 802. In aspects, to obtain the altitude, the base station 804 may be configured to measure (similarly to 812) the altitude of the UE 802 based on information received from the UE 802 or from another network node/entity. The base station 804 may be configured to provide an indication of the altitude of the UE 802 to the UE 802. The altitude of the UE 802 may be quantified with respect to ground, sea level, clutter, and/or the like.

At 1406, the UE measures a SSB value for each SSB in the set of SSBs based on the measurement object configuration and an altitude of the UE. As an example, the measurement may be performed, at least in part, by the component 198, the transceiver(s) 1722, and/or the antenna 1780 in FIG. 17. FIGS. 8-12 illustrate an example of the UE 802 measuring such SSB values for SSBs from a network node (e.g., the base station 804). FIG. 8 illustrates an example of a UE measuring a subset of SSBs based on an altitude of the UE.

The UE 802 may be configured to measure (at 812) a SSB value for each SSB (e.g., in 914 in FIG. 9; 1008 in FIG. 10; 1108 in FIG. 11; 1208 in FIG. 12) in the set of SSBs (e.g., from the number of the SSBs 810 provided/transmitted from the base station 804) for the at least one physical cell (e.g., 904 (Cell 1), 904′ (Cell 2), 904″ (Cell 3), in FIG. 9; 1104 in FIG. 11; 1208 in FIG. 12) based on the SMTC 808 (e.g., 914 in FIG. 9; 1000 in FIG. 10; 1100 in FIG. 11; 1200 in FIG. 12) and an altitude of the UE 802. For instance, the base station 804 may also be configured to provide/transmit the set of SSBs (e.g., in 914 in FIG. 9; 1008 in FIG. 10; 1108 in FIG. 11; 1208 in FIG. 12) for the UE 802. The base station 804 may be a service/serving cell or a neighboring cell, in aspects, and may be configured to transmit a number of SSBs 810 (e.g., in 914 in FIG. 9; 1008 in FIG. 10; 1108 in FIG. 11; 1208 in FIG. 12) for the UE 802 that includes the set of SSBs (e.g., in 914 in FIG. 9; 1008 in FIG. 10; 1108 in FIG. 11; 1208 in FIG. 12) indicated in the SMTC 808 (e.g., 914 in FIG. 9; 1000 in FIG. 10; 1100 in FIG. 11; 1200 in FIG. 12). In aspects, different base stations may be configured to transmit different numbers of the SSBs 810 (e.g., in 914 in FIG. 9; 1008 in FIG. 10; 1108 in FIG. 11; 1208 in FIG. 12) to the UE 802. A cell may be a physical cell with a corresponding PCI (e.g., 904 (Cell 1), 904′ (Cell 2), 904″ (Cell 3), in FIG. 9; 1104 in FIG. 11; 1208 in FIG. 12). In aspects, at least one physical cell (e.g., 904 (Cell 1), 904′ (Cell 2), 904″ (Cell 3), in FIG. 9; 1104 in FIG. 11; 1208 in FIG. 12) in an environment of the UE 802 may be a service/serving cell, and the SMTC 808 (e.g., 914 in FIG. 9; 1000 in FIG. 10) may be a cell-specific SMTC for the service/serving cell. In some aspects, at least one physical cell (e.g., 904 (Cell 1), 904′ (Cell 2), 904″ (Cell 3), in FIG. 9; 1104 in FIG. 11; 1208 in FIG. 12) in an environment of the UE 802 may include two or more physical cells (e.g., a service/serving cell and a neighbor cell) (e.g., 904 (Cell 1), 904′ (Cell 2), 904″ (Cell 3), in FIG. 9; 1104 in FIG. 11; 1208 in FIG. 12), and the SMTC 808 (e.g., 914 in FIG. 9; 1000 in FIG. 10; 1100 in FIG. 11; 1200 in FIG. 12) may configure the UE 802 for the physical cells (e.g., 904 (Cell 1), 904′ (Cell 2), 904″ (Cell 3), in FIG. 9; 1104 in FIG. 11; 1208 in FIG. 12), respectively, as described herein.

The UE 802 may be configured to report, e.g., for the base station 804, each measured SSB(s) 814 (e.g., in 914 in FIG. 9; 1008 in FIG. 10; 1108 in FIG. 11; 1208 in FIG. 12) in the set of SSBs (e.g., from the number of the SSBs 810 provided/transmitted from the base station 804) for the at least one physical cell (e.g., 904 (Cell 1), 904′ (Cell 2), 904″ (Cell 3), in FIG. 9; 1104 in FIG. 11; 1208 in FIG. 12) at the altitude of the UE 802, based on a reporting configuration that is associated with the altitude of the UE 802, and at least one of the altitude, a location, a velocity, or a speed of the UE 802. In aspects, the UE 802 may be configured to report each measured SSB(s) 814 (e.g., in 914 in FIG. 9; 1008 in FIG. 10; 1108 in FIG. 11; 1208 in FIG. 12) to the base station 804.

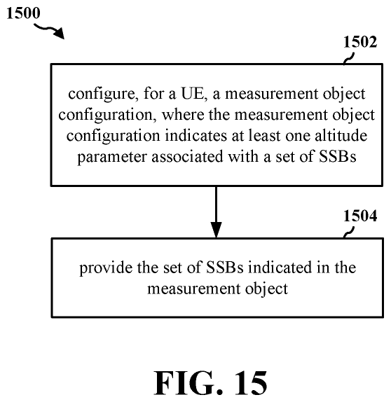

FIG. 15 is a flowchart 1500 of a method of wireless communication, in various aspects. The method may be performed by a base station (e.g., the base station 102, 402, 804, the first base station 904, the second base station 904′, the third base station 904″; the NR cell A 502, the NR cell B 504; the network entity 1702, 1802, 1960). In some aspects, the method may include aspects described in connection with the communication flow in FIG. 8 and/or aspects described in FIG. 4 or 9-12. The method provides for altitude-dependent measurement and reporting configurations that enable improvements for flexibility and accuracy for positioning and mobility measurements at a UE via configurations of altitude-specific measurements for synchronization signals. By enabling configurations of altitude-specific measurements with altitude ranges/intervals for synchronization signals, various aspects improve flexibility and accuracy for positioning and mobility measurements at a UE for specific synchronization signals based on UE altitude, e.g., for UAVs.

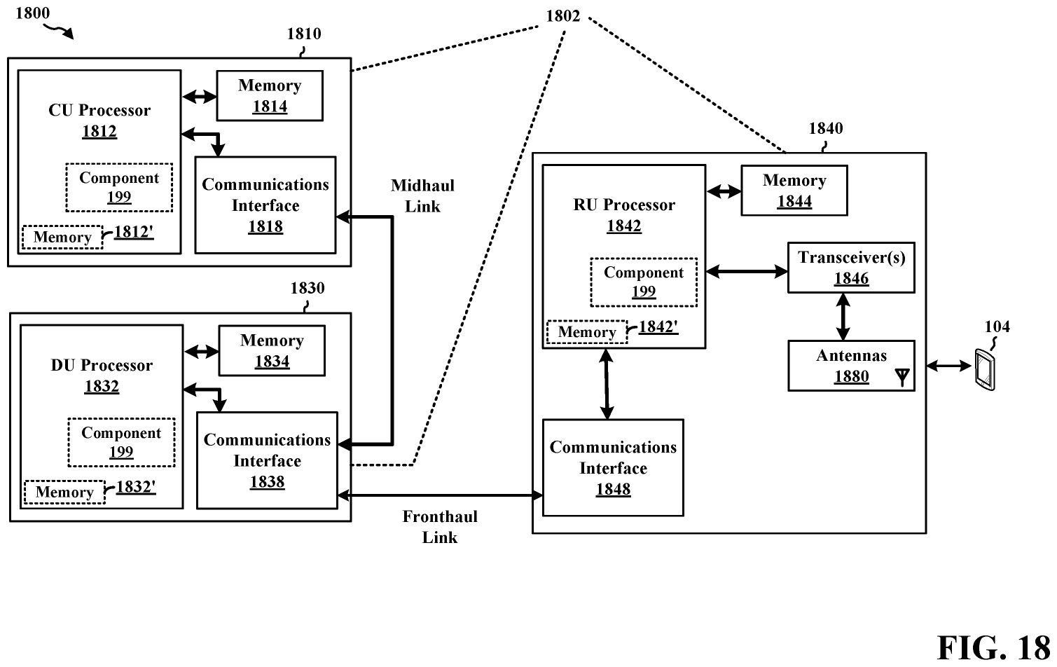

At 1502, a network node configures, for a UE, a SMTC, where the SMTC indicates an altitude range associated with at least one cell identifier that correspond to at least one physical cell, and a set of SSBs. As an example, the configuring may be performed, at least in part, by the component 199, the transceiver(s) 1846, and/or the antenna 1880 in FIG. 18. FIGS. 8-12 illustrate examples of the base station 804 configuring such a SMTC for a UE (e.g., the UE 802).

The base station 804 may configure (at 806) a SMTC 808 (e.g., 914 in FIG. 9; 1000 in FIG. 10; 1100 in FIG. 11; 1200 in FIG. 12) for the UE 802, where the SMTC 808 (e.g., 914 in FIG. 9; 1000 in FIG. 10; 1100 in FIG. 11; 1200 in FIG. 12) indicates an altitude range (or altitude parameter) (e.g., 906, 908, 910 in FIG. 9; for 1006 in FIG. 10; for 1106 in FIG. 11; for 1210 in FIG. 12) associated with at least one cell identifier that correspond to at least one physical cell (e.g., 904 (Cell 1), 904′ (Cell 2), 904″ (Cell 3), in FIG. 9; 1104 in FIG. 11; 1208 in FIG. 12), and a set of SSBs (e.g., in 914 in FIG. 9; 1008 in FIG. 10; 1108 in FIG. 11; 1208 in FIG. 12). In aspects, the SMTC 808 (e.g., 914 in FIG. 9; 1000 in FIG. 10; 1100 in FIG. 11; 1200 in FIG. 12) may include an added altitude-specific flexibility to a measurement object (e.g., measObjectNR) through indications of altitude-specific SSB(s) to measure (e.g., in 914 in FIG. 9; 1008 in FIG. 10; 1108 in FIG. 11; 1208 in FIG. 12). In aspects, this newly-added altitude-specific flexibility for measurement objects may be implemented for existing measObjectNR measurement objects. In aspects, new configurations for the SMTC 808 (e.g., 914 in FIG. 9; 1000 in FIG. 10; 1100 in FIG. 11; 1200 in FIG. 12) may include altitude ranges/intervals (e.g., 906, 908, 910 in FIG. 9; for 1006 in FIG. 10; for 1106 in FIG. 11; for 1210 in FIG. 12). In one example, different SSBs to measure (e.g., ssb-ToMeasure) (e.g., in 914 in FIG. 9; 1008 in FIG. 10; 1108 in FIG. 11; 1208 in FIG. 12) for different altitude ranges/intervals (e.g., 906, 908, 910 in FIG. 9; for 1006 in FIG. 10; for 1106 in FIG. 11; for 1210 in FIG. 12) may be included for an SSB-MTC configuration (e.g., 1110 in FIG. 11; 1210 in FIG. 12) of the SMTC 808 (e.g., 914 in FIG. 9; 1000 in FIG. 10; 1100 in FIG. 11; 1200 in FIG. 12). In another example, a new SSB-MTC list (e.g., 1202 in FIG. 12) may be included in a measurement object (e.g., measObjectNR), where each element of the new SSB-MTC list (e.g., 1202 in FIG. 12) may represent a SSB-MTC sub-configuration with a respective altitude range(s)/interval(s) (e.g., 906, 908, 910 in FIG. 9; for 1006 in FIG. 10; for 1106 in FIG. 11; for 1210 in FIG. 12). In aspects, a hysteresis value, which may define a hysteresis range (e.g., 912 in FIG. 9; for 1006 in FIG. 10; for 1106 in FIG. 11; for 1210 in FIG. 12), may be associated with an altitude range/interval boundary (e.g., 906, 908, 910 in FIG. 9; for 1006 in FIG. 10; for 1106 in FIG. 11; for 1210 in FIG. 12). The base station 804 may be configured to provide/transmit the SMTC 808 (e.g., 914 in FIG. 9; 1000 in FIG. 10; 1100 in FIG. 11; 1200 in FIG. 12) for the UE 802.

At 1504, the network node provides the set of SSBs indicated in the SMTC. As an example, the provision/transmission may be performed, at least in part, by the component 199, the transceiver(s) 1846, and/or the antenna 1880 in FIG. 18. FIGS. 8-12 illustrate examples of the base station 804 configuring such a SMTC for a UE (e.g., the UE 802). FIG. 8 illustrates an example of a base station transmitting SSBs in multiple beam directions. FIG. 5 illustrates an example of SSB bursts.

The base station 804 may also be configured to provide/transmit the set of SSBs (e.g., in 914 in FIG. 9; 1008 in FIG. 10; 1108 in FIG. 11; 1208 in FIG. 12) for the UE 802. The base station 804 may be a service/serving cell or a neighboring cell, in aspects, and may be configured to transmit a number of SSBs 810 (e.g., in 914 in FIG. 9; 1008 in FIG. 10; 1108 in FIG. 11; 1208 in FIG. 12) for the UE 802 that includes the set of SSBs (e.g., in 914 in FIG. 9; 1008 in FIG. 10; 1108 in FIG. 11; 1208 in FIG. 12) indicated in the SMTC 808 (e.g., 914 in FIG. 9; 1000 in FIG. 10; 1100 in FIG. 11; 1200 in FIG. 12). In aspects, different base stations may be configured to transmit different numbers of the SSBs 810 (e.g., in 914 in FIG. 9; 1008 in FIG. 10; 1108 in FIG. 11; 1208 in FIG. 12) to the UE 802. A cell may be a physical cell with a corresponding PCI (e.g., 904 (Cell 1), 904′ (Cell 2), 904″ (Cell 3), in FIG. 9; 1104 in FIG. 11; 1208 in FIG. 12). In aspects, at least one physical cell (e.g., 904 (Cell 1), 904′ (Cell 2), 904″ (Cell 3), in FIG. 9; 1104 in FIG. 11; 1208 in FIG. 12) in an environment of the UE 802 may be a service/serving cell, and the SMTC 808 (e.g., 914 in FIG. 9; 1000 in FIG. 10) may be a cell-specific SMTC for the service/serving cell. In some aspects, at least one physical cell in an environment of the UE 802 may include two or more physical cells (e.g., a service/serving cell and a neighbor cell) (e.g., 904 (Cell 1), 904′ (Cell 2), 904″ (Cell 3), in FIG. 9; 1104 in FIG. 11; 1208 in FIG. 12), and the SMTC 808 (e.g., 914 in FIG. 9; 1000 in FIG. 10; 1100 in FIG. 11; 1200 in FIG. 12) may configure the UE 802 for the physical cells (e.g., 904 (Cell 1), 904′ (Cell 2), 904″ (Cell 3), in FIG. 9; 1104 in FIG. 11; 1208 in FIG. 12), respectively, as described herein.

The UE 802 may be configured to report, e.g., for the base station 804, each measured SSB(s) 814 (e.g., in 914 in FIG. 9; 1008 in FIG. 10; 1108 in FIG. 11; 1208 in FIG. 12) in the set of SSBs (e.g., from the number of the SSBs 810 provided/transmitted from the base station 804) for the at least one physical cell (e.g., 904 (Cell 1), 904′ (Cell 2), 904″ (Cell 3), in FIG. 9; 1104 in FIG. 11; 1208 in FIG. 12) at the altitude of the UE 802, based on a reporting configuration that is associated with the altitude of the UE 802, and at least one of the altitude, a location, a velocity, or a speed of the UE 802. In aspects, the UE 802 may be configured to report each measured SSB(s) 814 (e.g., in 914 in FIG. 9; 1008 in FIG. 10; 1108 in FIG. 11; 1208 in FIG. 12) to the base station 804.

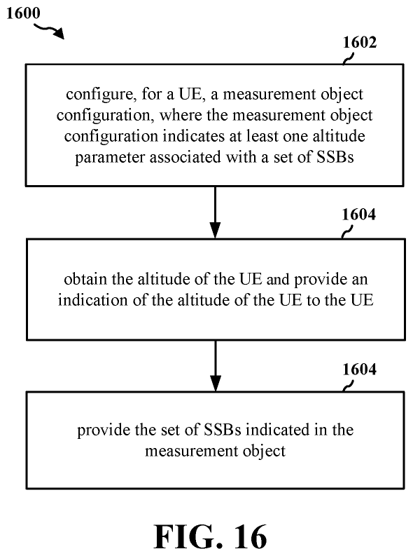

FIG. 16 is a flowchart 1600 of a method of wireless communication, in various aspects. The method may be performed by a base station (e.g., the base station 102, 402, 804, the first base station 904, the second base station 904′, the third base station 904″; the NR cell A 502, the NR cell B 504; the network entity 1702, 1802, 1960). In some aspects, the method may include aspects described in connection with the communication flow in FIG. 8 and/or aspects described in FIG. 4 or 9-12. The method provides for altitude-dependent measurement and reporting configurations that enable improvements for flexibility and accuracy for positioning and mobility measurements at a UE via configurations of altitude-specific measurements for synchronization signals. By enabling configurations of altitude-specific measurements with altitude ranges/intervals for synchronization signals, various aspects improve flexibility and accuracy for positioning and mobility measurements at a UE for specific synchronization signals based on UE altitude, e.g., for UAVs.

At 1602, a network node configures, for a UE, a SMTC, where the SMTC indicates an altitude range associated with at least one cell identifier that correspond to at least one physical cell, and a set of SSBs. As an example, the configuring may be performed, at least in part, by the component 199, the transceiver(s) 1846, and/or the antenna 1880 in FIG. 18. FIGS. 8-12 illustrate examples of the base station 804 configuring such a SMTC for a UE (e.g., the UE 802).

The base station 804 may configure (at 806) a SMTC 808 (e.g., 914 in FIG. 9; 1000 in FIG. 10; 1100 in FIG. 11; 1200 in FIG. 12) for the UE 802, where the SMTC 808 (e.g., 914 in FIG. 9; 1000 in FIG. 10; 1100 in FIG. 11; 1200 in FIG. 12) indicates an altitude range (or altitude parameter) (e.g., 906, 908, 910 in FIG. 9; for 1006 in FIG. 10; for 1106 in FIG. 11; for 1210 in FIG. 12) associated with at least one cell identifier that correspond to at least one physical cell (e.g., 904 (Cell 1), 904′ (Cell 2), 904″ (Cell 3), in FIG. 9; 1104 in FIG. 11; 1208 in FIG. 12), and a set of SSBs (e.g., in 914 in FIG. 9; 1008 in FIG. 10; 1108 in FIG. 11; 1208 in FIG. 12). In aspects, the SMTC 808 (e.g., 914 in FIG. 9; 1000 in FIG. 10; 1100 in FIG. 11; 1200 in FIG. 12) may include an added altitude-specific flexibility to a measurement object (e.g., measObjectNR) through indications of altitude-specific SSB(s) to measure (e.g., in 914 in FIG. 9; 1008 in FIG. 10; 1108 in FIG. 11; 1208 in FIG. 12). In aspects, this newly-added altitude-specific flexibility for measurement objects may be implemented for existing measObjectNR measurement objects. In aspects, new configurations for the SMTC 808 (e.g., 914 in FIG. 9; 1000 in FIG. 10; 1100 in FIG. 11; 1200 in FIG. 12) may include altitude ranges/intervals (e.g., 906, 908, 910 in FIG. 9; for 1006 in FIG. 10; for 1106 in FIG. 11; for 1210 in FIG. 12). In one example, different SSBs to measure (e.g., ssb-ToMeasure) (e.g., in 914 in FIG. 9; 1008 in FIG. 10; 1108 in FIG. 11; 1208 in FIG. 12) for different altitude ranges/intervals (e.g., 906, 908, 910 in FIG. 9; for 1006 in FIG. 10; for 1106 in FIG. 11; for 1210 in FIG. 12) may be included for an SSB-MTC configuration (e.g., 1110 in FIG. 11; 1210 in FIG. 12) of the SMTC 808 (e.g., 914 in FIG. 9; 1000 in FIG. 10; 1100 in FIG. 11; 1200 in FIG. 12). In another example, a new SSB-MTC list (e.g., 1202 in FIG. 12) may be included in a measurement object (e.g., measObjectNR), where each element of the new SSB-MTC list (e.g., 1202 in FIG. 12) may represent a SSB-MTC sub-configuration with a respective altitude range(s)/interval(s) (e.g., 906, 908, 910 in FIG. 9; for 1006 in FIG. 10; for 1106 in FIG. 11; for 1210 in FIG. 12). In aspects, a hysteresis value, which may define a hysteresis range (e.g., 912 in FIG. 9; for 1006 in FIG. 10; for 1106 in FIG. 11; for 1210 in FIG. 12), may be associated with an altitude range/interval boundary (e.g., 906, 908, 910 in FIG. 9; for 1006 in FIG. 10; for 1106 in FIG. 11; for 1210 in FIG. 12). The base station 804 may be configured to provide/transmit the SMTC 808 (e.g., 914 in FIG. 9; 1000 in FIG. 10; 1100 in FIG. 11; 1200 in FIG. 12) for the UE 802.

At 1604, the UE obtains the altitude of the UE and provides an indication of the altitude of the UE to the UE. As an example, the obtainment may be performed, at least in part, by the component 199, the transceiver(s) 1846, and/or the antenna 1880 in FIG. 18. FIGS. 8-12 illustrate examples of the base station 804 obtaining such an altitude for a UE (e.g., the UE 802).

A base station/network node may be configured to obtain the altitude of the UE, e.g., by being configured to measure the altitude of the UE based on information received from the UE or to receive an indication of the altitude of the UE from another network node or a network entity. The base station 804 may be configured to obtain the altitude of the UE 802. In aspects, to obtain the altitude, the base station 804 may be configured to measure (similarly to 812) the altitude of the UE 802 based on information received from the UE 802 or from another network node/entity. The base station 804 may be configured to provide an indication of the altitude of the UE 802 to the UE 802. The altitude of the UE 802 may be quantified with respect to ground, sea level, clutter, and/or the like.

At 1606, the network node provides the set of SSBs indicated in the SMTC. As an example, the provision/transmission may be performed, at least in part, by the component 199, the transceiver(s) 1846, and/or the antenna 1880 in FIG. 18. FIGS. 8-12 illustrate examples of the base station 804 configuring such a SMTC for a UE (e.g., the UE 802). FIG. 8 illustrates an example of a base station transmitting SSBs in multiple beam directions. FIG. 5 illustrates an example of SSB bursts.

The base station 804 may also be configured to provide/transmit the set of SSBs (e.g., in 914 in FIG. 9; 1008 in FIG. 10; 1108 in FIG. 11; 1208 in FIG. 12) for the UE 802. The base station 804 may be a service/serving cell or a neighboring cell, in aspects, and may be configured to transmit a number of SSBs 810 (e.g., in 914 in FIG. 9; 1008 in FIG. 10; 1108 in FIG. 11; 1208 in FIG. 12) for the UE 802 that includes the set of SSBs (e.g., in 914 in FIG. 9; 1008 in FIG. 10; 1108 in FIG. 11; 1208 in FIG. 12) indicated in the SMTC 808 (e.g., 914 in FIG. 9; 1000 in FIG. 10; 1100 in FIG. 11; 1200 in FIG. 12). In aspects, different base stations may be configured to transmit different numbers of the SSBs 810 (e.g., in 914 in FIG. 9; 1008 in FIG. 10; 1108 in FIG. 11; 1208 in FIG. 12) to the UE 802. A cell may be a physical cell with a corresponding PCI (e.g., 904 (Cell 1), 904′ (Cell 2), 904″ (Cell 3), in FIG. 9; 1104 in FIG. 11; 1208 in FIG. 12). In aspects, at least one physical cell (e.g., 904 (Cell 1), 904′ (Cell 2), 904″ (Cell 3), in FIG. 9; 1104 in FIG. 11; 1208 in FIG. 12) in an environment of the UE 802 may be a service/serving cell, and the SMTC 808 (e.g., 914 in FIG. 9; 1000 in FIG. 10) may be a cell-specific SMTC for the service/serving cell. In some aspects, at least one physical cell in an environment of the UE 802 may include two or more physical cells (e.g., a service/serving cell and a neighbor cell) (e.g., 904 (Cell 1), 904′ (Cell 2), 904″ (Cell 3), in FIG. 9; 1104 in FIG. 11; 1208 in FIG. 12), and the SMTC 808 (e.g., 914 in FIG. 9; 1000 in FIG. 10; 1100 in FIG. 11; 1200 in FIG. 12) may configure the UE 802 for the physical cells (e.g., 904 (Cell 1), 904′ (Cell 2), 904″ (Cell 3), in FIG. 9; 1104 in FIG. 11; 1208 in FIG. 12), respectively, as described herein.

The UE 802 may be configured to report, e.g., for the base station 804, each measured SSB(s) 814 (e.g., in 914 in FIG. 9; 1008 in FIG. 10; 1108 in FIG. 11; 1208 in FIG. 12) in the set of SSBs (e.g., from the number of the SSBs 810 provided/transmitted from the base station 804) for the at least one physical cell (e.g., 904 (Cell 1), 904′ (Cell 2), 904″ (Cell 3), in FIG. 9; 1104 in FIG. 11; 1208 in FIG. 12) at the altitude of the UE 802, based on a reporting configuration that is associated with the altitude of the UE 802, and at least one of the altitude, a location, a velocity, or a speed of the UE 802. In aspects, the UE 802 may be configured to report each measured SSB(s) 814 (e.g., in 914 in FIG. 9; 1008 in FIG. 10; 1108 in FIG. 11; 1208 in FIG. 12) to the base station 804.

FIG. 17 is a diagram 1700 illustrating an example of a hardware implementation for an apparatus 1704. The apparatus 1704 may be a UE, a component of a UE, or may implement UE functionality. In some aspects, the apparatus 1504 may include at least one cellular baseband processor 1724 (also referred to as a modem) coupled to one or more transceivers 1722 (e.g., cellular RF transceiver). The cellular baseband processor(s) 1724 may include at least one on-chip memory 1724′. In some aspects, the apparatus 1704 may further include one or more subscriber identity modules (SIM) cards 1720 and at least one application processor 1706 coupled to a secure digital (SD) card 1708 and a screen 1710. The application processor(s) 1706 may include on-chip memory 1706′. In some aspects, the apparatus 1704 may further include a Bluetooth module 1712, a WLAN module 1714, an SPS module 1716 (e.g., GNSS module), one or more sensor modules 1718 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1726, a power supply 1730, and/or a camera 1732. The Bluetooth module 1712, the WLAN module 1714, and the SPS module 1716 may include an on-chip transceiver (TRX) (or in some cases, just a receiver (RX)). The Bluetooth module 1712, the WLAN module 1714, and the SPS module 1716 may include their own dedicated antennas and/or utilize the antennas 1780 for communication. The cellular baseband processor(s) 1724 communicates through the transceiver(s) 1722 via one or more antennas 1780 with the UE 104 and/or with an RU associated with a network entity 1702. The cellular baseband processor(s) 1724 and the application processor(s) 1706 may each include a computer-readable medium/memory 1724′, 1706′, respectively. The additional memory modules 1726 may also be considered a computer-readable medium/memory. Each computer-readable medium/memory 1724′, 1706′, 1726 may be non-transitory. The cellular baseband processor(S) 1724 and the application processor(s) 1706 are each responsible for general processing, including the execution of software stored on the computer-readable medium/memory. The software, when executed by the cellular baseband processor(s) 1724/application processor(s) 1706, causes the cellular baseband processor(s) 1724/application processor(s) 1706 to perform the various functions described supra. The computer-readable medium/memory may also be used for storing data that is manipulated by the cellular baseband processor(s) 1724/application processor 1706 when executing software. The cellular baseband processor 1724/application processor(s) 1706 may be a component of the UE 350 and may include the at least one memory 360 and/or at least one of the TX processor 368, the RX processor 356, and the controller/processor 359. In one configuration, the apparatus 1704 may be at least one processor chip (modem and/or application) and include just the cellular baseband processor(s) 1724 and/or the application processor(s) 1706, and in another configuration, the apparatus 1704 may be the entire UE (e.g., see UE 350 of FIG. 3) and include the additional modules of the apparatus 1704.

As discussed supra, the component 198 may be configured to receive, from a network node, a measurement object configuration, where the measurement object configuration indicates at least one altitude parameter associated with a set of SSBs. The component 198 may also be configured to measure each SSB associated with the one or more cell identifiers based on an absence of a corresponding set of SSBs for the additional altitude parameter in the SMTC. The component 198 may be configured to obtain the altitude of the UE. To obtain the altitude of the UE, the component 198 may be configured to measure the altitude of the UE based on information received by the UE and/or receive an indication of the altitude of the UE from the network node or a network entity. The component 198 may be further configured to perform any of the aspects described in connection with the flowcharts in any of FIGS. 13-16, and/or any of the aspects performed by a UE for any of FIG. 4, 5, or 8-12. The component 198 may be within the cellular baseband processor(s) 1724, the application processor(s) 1706, or both the cellular baseband processor(s) 1724 and the application processor(s) 1706. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1704 may include a variety of components configured for various functions. In one configuration, the apparatus 1704, and in particular the cellular baseband processor(s) 1724 and/or the application processor(s) 1706, may include means for receiving, from a network node, a measurement object configuration, where the measurement object configuration indicates at least one altitude parameter associated with a set of SSBs. In the configuration, the apparatus 1704, and in particular the cellular baseband processor 1724 and/or the application processor 1706, may include means for measuring a SSB value for each SSB in the set of SSBs based on the measurement object configuration and an altitude of the UE. In one configuration, the apparatus 1704, and in particular the cellular baseband processor 1724 and/or the application processor 1706, may include means for measuring a second SSB value for each SSB associated with the one or more cell identifiers based on an absence of a corresponding set of SSBs for the additional altitude range in the SMTC. In one configuration, the apparatus 1704, and in particular the cellular baseband processor 1724 and/or the application processor 1706, may include means for obtaining the altitude of the UE. To obtain the altitude of the UE, the apparatus 1704, and in particular the cellular baseband processor 1724 and/or the application processor 1706, may include means for means for measuring the altitude of the UE based on information received by the UE and/or receiving an indication of the altitude of the UE from the network node or a network entity. The apparatus may further include means for performing any of the aspects described in connection with the flowcharts in any of FIGS. 13-16, and/or any of the aspects performed by a UE for any of FIG. 4, 5, or 8-12. The means may be the component 198 of the apparatus 1704 configured to perform the functions recited by the means. As described supra, the apparatus 1704 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 18 is a diagram 1800 illustrating an example of a hardware implementation for a network entity 1802. The network entity 1802 may be a BS, a component of a BS, or may implement BS functionality. The network entity 1802 may include at least one of a CU 1810, a DU 1830, or an RU 1840. For example, depending on the layer functionality handled by the component 199, the network entity 1802 may include the CU 1810; both the CU 1810 and the DU 1830; each of the CU 1810, the DU 1830, and the RU 1840; the DU 1830; both the DU 1830 and the RU 1840; or the RU 1840. The CU 1810 may include at least one CU processor 1812. The CU processor(s) 1812 may include on-chip memory 1812′. In some aspects, the CU 1810 may further include additional memory modules 1814 and a communications interface 1818. The CU 1810 communicates with the DU 1830 through a midhaul link, such as an F1 interface. The DU 1830 may include at least one DU processor 1832. The DU processor(s) 1832 may include on-chip memory 1832′. In some aspects, the DU 1830 may further include additional memory modules 1834 and a communications interface 1838. The DU 1830 communicates with the RU 1840 through a fronthaul link. The RU 1840 may include at least one RU processor 1842. The RU processor(s) 1842 may include on-chip memory 1842′. In some aspects, the RU 1840 may further include additional memory modules 1844, one or more transceivers 1846, antennas 1880, and a communications interface 1848. The RU 1840 communicates with the UE 104. The on-chip memory 1812′, 1832′, 1842′ and the additional memory modules 1814, 1834, 1844 may each be considered a computer-readable medium/memory. Each computer-readable medium/memory may be non-transitory. Each of the processors 1812, 1832, 1842 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to configure, for a UE, a measurement object configuration, wherein the measurement object configuration indicates at least one altitude parameter associated with a set of SSBs. The component 199 may also be configured to provide the set of SSBs indicated in the measurement object configuration. The component 199 may be configured to obtain an altitude of the UE and provide an indication of the altitude of the UE to the UE. The component 199 may be configured to measure the altitude of the UE based on information received from the UE. The component 199 may be configured to transmit, for the UE, an indication of the altitude of the UE. The component 199 may be further configured to perform any of the aspects described in connection with the flowcharts in any of FIGS. 13-16, and/or any of the aspects performed by a network node/base station for any of FIG. 4, 5, or 8-12. The component 199 may be within one or more processors of one or more of the CU 1810, DU 1830, and the RU 1840. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1802 may include a variety of components configured for various functions. In one configuration, the network entity 1802 may include means for configuring, for a UE, a measurement object configuration, where the measurement object configuration indicates at least one altitude parameter associated with a set of SSBs. In the configuration, the network entity 1802 may include means for providing the set of SSBs indicated in the measurement object configuration. In one configuration, the network entity 1802 may include means for obtaining an altitude of the UE and providing an indication of the altitude of the UE to the UE. In one configuration, the network entity 1802 may include means for measuring the altitude of the UE based on information received from the UE. In one configuration, the network entity 1802 may include means for transmitting, for the UE, an indication of the altitude of the UE. In one configuration, the network entity 1802 may include means for receiving an SSB value for each measured SSB in the set of SSBs for the at least one physical cell at an altitude of the UE, based on a reporting configuration that is associated with an altitude of the UE, and at least one of the altitude, a location, a velocity, or a speed of the UE. The network entity may further include means for performing any of the aspects described in connection with the flowcharts in any of FIGS. 13-16, and/or any of the aspects performed by a network node/base station for any of FIG. 4, 5, or 8-12. The means may be the component 199 of the network entity 1802 configured to perform the functions recited by the means. As described supra, the network entity 1802 may include the TX processor 316, the RX processor 370, and the controller/processor 375. As such, in one configuration, the means may be the TX processor 316, the RX processor 370, and/or the controller/processor 375 configured to perform the functions recited by the means.

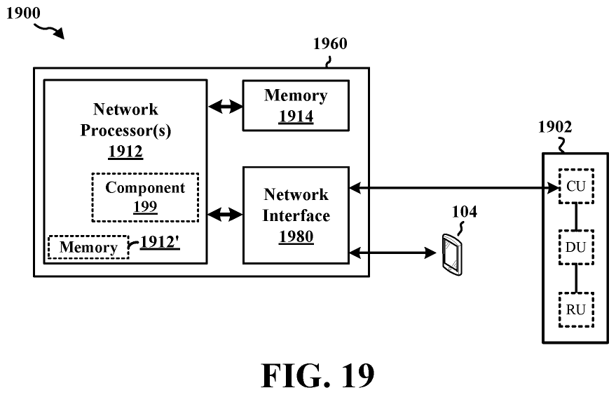

FIG. 19 is a diagram 1900 illustrating an example of a hardware implementation for a network entity 1960. In one example, the network entity 1960 may be within the core network 120. The network entity 1960 may include at least one network processor 1912. The network processor(s) 1912 may include on-chip memory 1912′. In some aspects, the network entity 1960 may further include additional memory modules 1914. The network entity 1960 communicates via the network interface 1980 directly (e.g., backhaul link) or indirectly (e.g., through a RIC) with the CU 1902 and/or with the UE 104. The on-chip memory 1912′ and the additional memory modules 1914 may each be considered a computer-readable medium/memory. Each computer-readable medium/memory may be non-transitory. The network processor(s) 1912 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to configure, for a UE, a measurement object configuration, wherein the measurement object configuration indicates at least one altitude parameter associated with a set of SSBs. The component 199 may also be configured to provide the set of SSBs indicated in the measurement object configuration. The component 199 may be configured to obtain an altitude of the UE and provide an indication of the altitude of the UE to the UE. The component 199 may be configured to measure the altitude of the UE based on information received from the UE. The component 199 may be configured to transmit, for the UE, an indication of the altitude of the UE. The component 199 may be further configured to perform any of the aspects described in connection with the flowcharts in any of FIGS. 13-16, and/or any of the aspects performed by a network node/base station for any of FIG. 4, 5, or 8-12. The component 199 may be within the network processor(s) 1912. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1960 may include a variety of components configured for various functions. In one configuration, the network entity 1802 may include means for configuring, for a UE, a measurement object configuration, where the measurement object configuration indicates at least one altitude parameter associated with a set of SSBs. In the configuration, the network entity 1802 may include means for providing the set of SSBs indicated in the measurement object configuration. In one configuration, the network entity 1802 may include means for obtaining an altitude of the UE and providing an indication of the altitude of the UE to the UE. In one configuration, the network entity 1802 may include means for measuring the altitude of the UE based on information received from the UE. In one configuration, the network entity 1802 may include means for transmitting, for the UE, an indication of the altitude of the UE. In one configuration, the network entity 1802 may include means for receiving an SSB value for each measured SSB in the set of SSBs for the at least one physical cell at an altitude of the UE, based on a reporting configuration that is associated with an altitude of the UE, and at least one of the altitude, a location, a velocity, or a speed of the UE. The network entity may further include means for performing any of the aspects described in connection with the flowcharts in any of FIGS. 13-16, and/or any of the aspects performed by a network node/base station for any of FIG. 4, 5, or 8-12. The means may be the component 199 of the network entity 1960 configured to perform the functions recited by the means.

Wireless communication networks may enable measurements of beams by UEs, e.g., for mobility operations. In a 5G NR network, as one example, a given physical cell may have multiple beams, and thus, a UE may measure multiple SSBs. Configurations for such measurements may include a bitmap (“ssb-ToMeasure”) that indicates a set of SSBs to measure within a SMTC measurement duration. The ssb-ToMeasure may a single bitmap in a SSB-ConfigMobility object and may apply to all measurements in configurations, e.g., “smtc” and “smtc2,” for a given measObjectNR measurement object. However, multiple measObject configurations for a given SSB frequency (“ssbFrequency”) may not be enabled or allowed for a cell group. For instance, some wireless networks may be implemented to ensure that, in the measurement configuration (“measConfig”) associated with a configured grant (CG): (1) for all SSB based measurements there is at most one measurement object with the same ssbFrequency; and/or (2) an “smtc1” included in any measurement object with the same ssbFrequency has the same value, and that an smtc2 included in any measurement object with the same ssbFrequency has the same value, and that an “smtc3list” included in any measurement object with the same ssbFrequency has the same value, and that an “smtc4list” included in any measurement object with the same ssbFrequency has the same value. Yet, for a given altitude range in which the UE is present, additional flexibility for cell-specific beam measurements beyond what is provided in current solutions may improve beam measurements. Aspects herein enable SMTCs with flexibility that allow for a UE (e.g., an unmanned aerial vehicle (UAV)) to measure a first set of beams (or (cell, beam) ordered pairs) at one altitude range (e.g., below or level with clutter) and a different set of beams at a different altitude range (e.g., above a certain altitude where line of sight (LOS) is usually expected), including for different cells.

Various aspects herein for altitude-dependent measurement and reporting configurations improve flexibility and accuracy for positioning and mobility measurements at a UE via configurations of altitude-specific measurements for synchronization signals. By enabling configurations of altitude-specific measurements with altitude ranges/intervals for synchronization signals, various aspects improve flexibility and accuracy for positioning and mobility measurements at a UE for specific synchronization signals based on UE altitude, e.g., for UAVs. Additionally, various aspects provide SSB-MTC sub-configurations where each element of the SSB-MTC lists flexibly allows altitude ranges for flexibility and accuracy for positioning and mobility measurements at a UE for specific synchronization signals based on UE altitude through configurations of altitude-specific measurements with SSB-MTC lists in measurement objects.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module (also “at least one memory/memory module”) may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a user equipment (UE), including: receiving, from a network node, a measurement object configuration, where the measurement object configuration indicates at least one altitude parameter associated with a set of SSBs; and measuring a SSB value for each SSB in the set of SSBs based on the measurement object configuration and an altitude of the UE.
Aspect 2 is the method of aspect 1, where the measurement object configuration includes a synchronization signal block (SSB) measurement time configuration (SMTC).
Aspect 3 is the method of any of aspects 1 and 2, where the at least one altitude parameter includes at least one of a minimum altitude value or a maximum altitude value.
Aspect 4 is the method of aspect 3, where the UE utilizes a default minimum altitude value of zero in a first absence of the minimum altitude value for the altitude range; or where the UE utilizes a default maximum altitude value of infinity in a second absence of the maximum altitude value for the altitude range.
Aspect 5 is the method of any of aspects 1 to 4, where the at least one altitude parameter is associated with a hysteresis value.
Aspect 6 is the method of any of aspects 1 to 5, where the measurement object configuration includes a synchronization signal block (SSB) measurement time configuration (SMTC) that is associated with the at least one altitude parameter or a SMTC measurement duration, where the measurement object configuration comprises multiple altitude ranges.
Aspect 7 is the method of aspect 6, where the at least one altitude parameter is associated with a hysteresis value; or where each altitude range of the multiple altitude ranges is associated with a corresponding set of at least one cell identifier and a corresponding set of SSBs.
Aspect 8 is the method of any of aspects 1 to 7, where the UE is associated with an unmanned aerial vehicle (UAV).
Aspect 9 is the method of any of aspects 1 to 8, where the measurement object configuration includes a synchronization signal block (SSB) measurement time configuration (SMTC), where the SMTC includes an additional altitude parameter, where measuring the SSB value for each SSB in the set of SSBs includes: measuring each SSB associated with one or more cell identifiers based on an absence of a corresponding set of SSBs for the additional altitude parameter in the SMTC.
Aspect 10 is the method of any of aspects 1 to 9, where the at least one altitude parameter comprises an altitude range, and where the altitude range is associated with an altitude list in a measurement object in the measurement object configuration.
Aspect 11 is the method of any of aspects 1 to 10, where the measurement object configuration includes a synchronization signal block (SSB) measurement time configuration (SMTC), where the at least one altitude parameter comprises an altitude range, where the altitude range is associated with an altitude list in the SMTC.
Aspect 12 is the method of aspect 11, where the SMTC includes a cell list that indicates a set of cell identifiers.
Aspect 13 is the method of any of aspects 1 to 12, where the at least one altitude parameter comprises an altitude range, where the altitude range is associated with a synchronization signal block (SSB) measurement time configuration (SMTC) list in a SMTC included with the measurement object configuration, and where each of one or more altitude ranges respectively corresponds to an SMTC sub-configuration that includes at least one of: a cell list that indicates a corresponding set of cell identifiers; a burst periodicity of a corresponding set of SSBs; or the set of SSBs, where the set of SSBs is associated with a physical cell during a SMTC window.
Aspect 14 is the method of any of aspects 1 to 12, further including: obtaining the altitude of the UE based on at least one of: measuring the altitude of the UE based on information received by the UE; or receiving an indication of the altitude of the UE from the network node or a network entity.
Aspect 15 is a method of wireless communication at a network node, including: configuring for a user equipment (UE), a measurement object configuration, where the measurement object configuration indicates at least one altitude parameter associated with a set of SSBs; and providing the set of SSBs indicated in the measurement object configuration.
Aspect 16 is the method of aspect 15, where the measurement object configuration includes a synchronization signal block (SSB) measurement time configuration (SMTC).
Aspect 17 is the method of any of aspects 15 and 16, where the at least one altitude parameter comprises an altitude range that includes at least one of a minimum altitude value or a maximum altitude value.
Aspect 18 is the method of any of aspects 15 and 16, where the UE utilizes a default minimum altitude value of zero in a first absence of the minimum altitude value for the altitude range; or where the UE utilizes a default maximum altitude value of infinity in a second absence of the maximum altitude value for the altitude range.
Aspect 19 is the method of any of aspects 15 to 16, where the at least one altitude parameter is associated with a hysteresis value.
Aspect 20 is the method of any of aspects 15 to 19, where the measurement object configuration includes a synchronization signal block (SSB) measurement time configuration (SMTC) that is associated with the at least one altitude parameter or a SMTC measurement duration, where the measurement object configuration comprises multiple altitude ranges.
Aspect 21 is the method of any of aspects 15 to 20, where the at least one altitude parameter is associated with a hysteresis value; or where each altitude range of the multiple altitude ranges is associated with a corresponding set of at least one cell identifier and a corresponding set of SSBs.
Aspect 22 is the method of any of aspects 15 to 21, where the UE is associated with an unmanned aerial vehicle (UAV).
Aspect 23 is the method of any of aspects 15 to 22, where the measurement object configuration includes a synchronization signal block (SSB) measurement time configuration (SMTC), where the SMTC includes an additional altitude parameter, where the additional altitude parameter has an absence of a corresponding set of SSBs in the SMTC.
Aspect 24 is the method of any of aspects 15 to 23, where the at least one altitude parameter comprises an altitude range, and where the altitude range is associated with an altitude list in a measurement object in the measurement object configuration.
Aspect 25 is the method of any of aspects 15 to 24, where the measurement object configuration includes a synchronization signal block (SSB) measurement time configuration (SMTC), where the at least one altitude parameter comprises an altitude range, where the altitude range is associated with an altitude list in the SMTC.
Aspect 26 is the method of aspect 25, where the SMTC includes a cell list that indicates a set of cell identifiers.
Aspect 27 is the method of any of aspects 15 to 26, where the at least one altitude parameter comprises an altitude range, where the altitude range is associated with a synchronization signal block (SSB) measurement time configuration (SMTC) list in a SMTC included with the measurement object configuration, and where each of one or more altitude ranges respectively corresponds to an SMTC sub-configuration that includes at least one of: a cell list that indicates a corresponding set of cell identifiers; a burst periodicity of a corresponding set of SSBs; or the set of SSBs, where the set of SSBs is associated with a physical cell during a SMTC window.
Aspect 28 is the method of any of aspects 15 to 27, further comprising: obtaining the altitude of the UE; where, obtaining the altitude of the UE includes at least one of measuring the altitude of the UE based on information received from the UE; or transmitting an indication of the altitude of the UE.
Aspect 29 is a method of wireless communication at a network node, including: receiving, from a network node, a measurement object configuration, where the measurement object configuration indicates at least one altitude parameter associated with a set of SSBs, where the at least one altitude parameter includes a hysteresis value; and measuring a SSB value for each SSB in the set of SSBs based on the measurement object configuration and an altitude of the UE.
Aspect 30 is a method of wireless communication at a network node, including: configuring for a user equipment (UE), a measurement object configuration, where the measurement object configuration indicates at least one altitude parameter associated with a set of SSBs, where the at least one altitude parameter includes a hysteresis value; and providing the set of SSBs indicated in the measurement object configuration.
Aspect 31 is an apparatus for wireless communication including means for implementing any of aspects 1 to 14.
Aspect 32 is a computer-readable medium (e.g., a non-transitory computer-readable medium) storing computer executable code, the code when executed by at least one processor causes the at least one processor to implement any of aspects 1 to 14.
Aspect 33 is an apparatus for wireless communication at a network node. The apparatus includes at least one memory; and at least one processor coupled to the at least one memory and, based at least in part on information stored in the at least one memory, the at least one processor is configured to implement any of aspects 1 to 14.
Aspect 34 is the apparatus of aspect 33, further including at least one of a transceiver or an antenna coupled to the at least one processor.
Aspect 35 is an apparatus for wireless communication including means for implementing any of aspects 15 to 28.
Aspect 36 is a computer-readable medium (e.g., a non-transitory computer-readable medium) storing computer executable code, the code when executed by at least one processor causes the at least one processor to implement any of aspects 15 to 28.
Aspect 37 is an apparatus for wireless communication at a network node. The apparatus includes a at least one memory; and at least one processor coupled to the at least one memory and, based at least in part on information stored in the at least one memory, the at least one processor is configured to implement any of aspects 15 to 28.
Aspect 38 is the apparatus of aspect 37, further including at least one of a transceiver or an antenna coupled to the at least one processor.

What is claimed is:

1. An apparatus for wireless communication at a user equipment (UE), comprising:
at least one memory; and
at least one processor coupled to the at least one memory and, based at least in part on stored information that is stored in the at least one memory, the at least one processor is configured to:
receive, from a network node, a measurement object configuration, wherein the measurement object configuration indicates at least one altitude parameter associated with a set of SSBs; and
measure a SSB value for each SSB in the set of SSBs based on the measurement object configuration and an altitude of the UE.

2. The apparatus of claim 1, wherein the measurement object configuration includes a synchronization signal block (SSB) measurement time configuration (SMTC).

3. The apparatus of claim 1, wherein the at least one altitude parameter comprises an altitude range that includes at least one of a minimum altitude value or a maximum altitude value.

4. The apparatus of claim 3, wherein the UE utilizes a default minimum altitude value of zero in a first absence of the minimum altitude value for the altitude range; or
wherein the UE utilizes a default maximum altitude value of infinity in a second absence of the maximum altitude value for the altitude range.

5. The apparatus of claim 1, wherein the at least one altitude parameter is associated with a hysteresis value.

6. The apparatus of claim 1, wherein the measurement object configuration includes a synchronization signal block (SSB) measurement time configuration (SMTC) that is associated with the at least one altitude parameter or a SMTC measurement duration, wherein the measurement object configuration comprises multiple altitude ranges.

7. The apparatus of claim 6, wherein the at least one altitude parameter is associated with a hysteresis value; or
wherein each altitude range of the multiple altitude ranges is associated with a corresponding set of at least one cell identifier and a corresponding set of SSBs.

8. The apparatus of claim 1, wherein the UE is associated with an unmanned aerial vehicle (UAV).

9. The apparatus of claim 1, wherein the measurement object configuration includes a synchronization signal block (SSB) measurement time configuration (SMTC), wherein the SMTC includes an additional altitude parameter, wherein to measure the SSB value for each SSB in the set of SSBs, the at least one processor is configured to:
measure each SSB associated with one or more cell identifiers based on an absence of a corresponding set of SSBs for the additional altitude parameter in the SMTC.

10. The apparatus of claim 1, wherein the at least one altitude parameter comprises an altitude range, and wherein the altitude range is associated with an altitude list in a measurement object in the measurement object configuration.

11. The apparatus of claim 1, wherein the measurement object configuration includes a synchronization signal block (SSB) measurement time configuration (SMTC), wherein the at least one altitude parameter comprises an altitude range, wherein the altitude range is associated with an altitude list in the SMTC.

12. The apparatus of claim 11, wherein the SMTC includes a cell list that indicates a set of cell identifiers.

13. The apparatus of claim 1, wherein the at least one altitude parameter comprises an altitude range, wherein the altitude range is associated with a synchronization signal block (SSB) measurement time configuration (SMTC) list in a SMTC included with the measurement object configuration, and wherein each of one or more altitude ranges respectively corresponds to an SMTC sub-configuration that includes at least one of:
a cell list that indicates a corresponding set of cell identifiers;
a burst periodicity of a corresponding set of SSBs; or
the set of SSBs, wherein the set of SSBs is associated with a physical cell during a SMTC window.

14. The apparatus of claim 1, wherein the at least one processor is further configured to: obtain the altitude of the UE;
wherein, to obtain the altitude of the UE, the at least one processor is configured to perform at least one of:
measure the altitude of the UE based on information received by the UE; or
receive an indication of the altitude of the UE from the network node or a network entity.

15. An apparatus for wireless communication at a network node, comprising:
at least one memory; and
at least one processor coupled to the at least one memory and, based at least in part on stored information that is stored in the at least one memory, the at least one processor is configured to:
configure, for a user equipment (UE), a measurement object configuration, wherein the measurement object configuration indicates at least one altitude parameter associated with a set of SSBs; and
provide the set of SSBs indicated in the measurement object configuration.

16. The apparatus of claim 15, wherein the measurement object configuration includes a synchronization signal block (SSB) measurement time configuration (SMTC); or
wherein the at least one altitude parameter comprises an altitude range that includes at least one of a minimum altitude value or a maximum altitude value;
wherein the at least one altitude parameter is associated with a hysteresis value; or
wherein the UE is associated with an unmanned aerial vehicle (UAV).

17. The apparatus of claim 16, wherein the UE utilizes a default minimum altitude value of zero in a first absence of the minimum altitude value for the altitude range; or
wherein the UE utilizes a default maximum altitude value of infinity in a second absence of the maximum altitude value for the altitude range.

18. The apparatus of claim 15, (i) wherein the measurement object configuration includes a first synchronization signal block (SSB) measurement time configuration (SMTC) that is associated with the at least one altitude parameter or a SMTC measurement duration, wherein the measurement object configuration comprises multiple altitude ranges;
(ii) wherein the measurement object configuration includes a second SMTC, wherein the second SMTC includes an additional altitude parameter, wherein the additional altitude parameter has an absence of a first corresponding set of SSBs in the second SMTC;
(iii) wherein the at least one altitude parameter comprises a first altitude range, and wherein the first altitude range is associated with a first altitude list in a measurement object in the measurement object configuration;
(iv) wherein the measurement object configuration includes a third SMTC, wherein the at least one altitude parameter comprises a second altitude range, wherein the second altitude range is associated with a second altitude list in the third SMTC;
(v) wherein the at least one altitude parameter comprises a third altitude range, wherein the third altitude range is associated with a SMTC list in a fourth SMTC included with the measurement object configuration, and wherein each of one or more altitude ranges respectively corresponds to an SMTC sub-configuration that includes at least one of:
a first cell list that indicates a corresponding set of cell identifiers,
a burst periodicity of a second corresponding set of SSBs, or
the set of SSBs, wherein the set of SSBs is associated with a physical cell during a SMTC window; or
(vi) wherein the at least one processor is further configured to:
obtain an altitude of the UE; and
provide an indication of the altitude of the UE to the UE.

19. The apparatus of claim 18 wherein the at least one altitude parameter is associated with a hysteresis value;
wherein each altitude range of the multiple altitude ranges is associated with a corresponding set of at least one cell identifier and a third corresponding set of SSBs; or
wherein the third SMTC includes a second cell list that indicates a set of cell identifiers.

20. A method of wireless communication at a user equipment (UE), comprising:
receiving, from a network node, a measurement object configuration, wherein the measurement object configuration indicates at least one altitude parameter associated with a set of SSBs; and
measuring a SSB value for each SSB in the set of SSBs based on the measurement object configuration and an altitude of the UE.
